(19) United States
(12) Patent Application Publication
(10) Pub. No.: US 2023/0350006 A1
(43) Pub. Date: Nov. 2, 2023

(54) RADAR REFERENCE SIGNAL FOR JOINT COMMUNICATION RADAR

(71) Applicant: QUALCOMM Incorporated, San Diego, CA (US)

(72) Inventors: Preeti Kumari, San Diego, CA (US); Junyi Li, Fairless Hills, PA (US); Kapil Gulati, Belle Mead, NJ (US); Sony Akkarakaran, Poway, CA (US); Gene Wesley Marsh, San Diego, CA (US); Shailesh Patil, San Diego, CA (US); Arthur Gubeskys, San Diego, CA (US)

(21) Appl. No.: 17/734,349

(22) Filed: May 2, 2022

(51) Int. Cl. G01S 7/00; H04L 5/00; H04W 76/10; G01S 7/02

(52) U.S. Cl. CPC G01S 7/003; H04L 5/0048; H04W 76/10; G01S 7/0235; G01S 2013/9316

(57) ABSTRACT

Methods, systems, and devices for wireless communications are described. A wireless device may receive, from a network entity, a control message for a radar reference signal (RRS) configuration associated with the wireless device. The wireless device may set a timing pattern for the RRS based on the control message and one or more timing parameters for the RRS configuration. The wireless device may transmit the RRS according to the timing pattern. The RRS may include one or more cyclic prefix (CP) sub-symbols and one or more RRS sub-symbols. The wireless device may receive one or more reflections of the RRS and may perform one or more processing operations on the one or more reflections of the RRS using a plurality of sampling windows. A quantity of sampling windows may be equal to a quantity of CP sub-symbols.

### FIELD OF TECHNOLOGY

The following relates to wireless communications, including a radar reference signal (RRS) for joint communication radar (JCR).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

A wireless communications system may support radar devices, which may reflect radar signaling off of a target (e.g., an opaque object) to determine one or more properties associated with the target. For example, a radar device may transmit a waveform in the direction of a target. The target may reflect the waveform, which may be received by the radar device or a receiving component associated with the radar device. The radar device may determine a distance and a velocity of the target based on the received waveform. In some cases, a waveform for radar signaling may be transmitted in one or more directions, simultaneously. As a result, multiple instances (e.g., repetitions) of a radar signal may reach a receiver at varying times based on a pathlength of each respective instance of the radar signal.

In some cases, a radar device may transmit both radar signaling and communication-based signaling (e.g., using a same waveform configuration). Such radar devices may be referred to as joint communication radars (JCRs). In some cases, a JCR may transmit signaling (e.g., for radar, for communications, or both) based on one or more parameters, which may resource timing or other aspects associated with the utilization of time-frequency resources. For example, the JCR may transmit signaling based on one or more parameters (e.g., timing parameters), which may specify a quantity and a duration of cyclic prefixes (CPs) included in the signaling. However, a JCR may be unable to select one or more parameters to effectively transmit both radar and communication-based signaling. For example, a JCR may be unable to tune one or more parameters to achieve desired one or more desired performance outcomes for both radar and communication-based signaling.

### SUMMARY

The described techniques relate to improved methods, systems, devices, and apparatuses that support a radar reference signal (RRS) for joint communication radar (JCR). Generally, the described techniques provide for a wireless device, such as a JCR, transmitting an RRS using a timing pattern (e.g., a slot structure, a resource timing) that enables effective radar and communication-based signaling. For example, the RRS may enable a wireless device to increase a range associated with radar signaling without decreasing a data rate. The RRS may additionally or alternatively reduce or eliminate inter-carrier interference (ICI) and inter-symbol interference (ISI). In some cases, the wireless device may receive a control message from a network entity and the wireless device may configure the RRS (e.g., the RRS timing pattern) based on the control message. The timing pattern for the RRS may include multiple repetitions of a cyclic prefix (CP) as well as an RRS symbol (e.g., an “RRS Main”).

The wireless device may sample (e.g., using Fast Fourier Transforms (FFTs)) the received signals using a same quantity of sampling windows as the quantity of CP repetitions, which may enable the wireless device to reduce or eliminate ISI and ICI. The wireless device may receive, from a network entity, an indication including one or more timing parameters which specify the RRS timing pattern. In some cases, the indication may include one or more performance parameters associated with a performance of the wireless device. In some cases, the wireless device may determine the RRS timing pattern based on one or more rules specified by the network entity.

A method for wireless communications at a wireless device is described. The method may include receiving, from a network entity, a control message for an RRS configuration associated with the wireless device, setting a timing pattern for the RRS configuration based on the control message and one or more timing parameters for the RRS configuration, and transmitting an RRS according to the timing pattern.

An apparatus for wireless communications at a wireless device is described. The apparatus may include a processor, memory coupled with the processor, and instructions stored in the memory. The instructions may be executable by the processor to cause the apparatus to receive, from a network entity, a control message for an RRS configuration associated with the wireless device, set a timing pattern for the RRS configuration based on the control message and one or more timing parameters for the RRS configuration, and transmit an RRS according to the timing pattern.

Another apparatus for wireless communications at a wireless device is described. The apparatus may include means for receiving, from a network entity, a control message for an RRS configuration associated with the wireless device, means for setting a timing pattern for the RRS configuration based on the control message and one or more timing parameters for the RRS configuration, and means for transmitting an RRS according to the timing pattern.

A non-transitory computer-readable medium storing code for wireless communications at a wireless device is described. The code may include instructions executable by a processor to receive, from a network entity, a control message for an RRS configuration associated with the wireless device, set a timing pattern for the RRS configuration based on the control message and one or more timing parameters for the RRS configuration, and transmit an RRS according to the timing pattern.

In some examples of the method, apparatuses, and non-transitory computer-readable medium described herein, transmitting the RRS may include operations, features, means, or instructions for transmitting the RRS including one or more cyclic prefix (CP) sub-symbols and one or more RRS sub-symbols.

Some examples of the method, apparatuses, and non-transitory computer-readable medium described herein may further include operations, features, means, or instructions for receiving one or more reflections of the RRS based on transmitting the RRS and performing one or more processing operations on the one or more reflections of the RRS using a set of multiple sampling windows, where a quantity of sampling windows may be equal to a quantity of CP sub-symbols.

In some examples of the method, apparatuses, and non-transitory computer-readable medium described herein, transmitting the RRS may include operations, features, means, or instructions for transmitting a quantity of repetitions of the RRS based on a timing parameter of the one or more timing parameters.

In some examples of the method, apparatuses, and non-transitory computer-readable medium described herein, transmitting the quantity of repetitions of the RRS may include operations, features, means, or instructions for transmitting the quantity of repetitions of the RRS, where repetitions of the RRS may be separated by one or more sub-symbols, separated by one or more guard intervals, or a combination thereof.

In some examples of the method, apparatuses, and non-transitory computer-readable medium described herein, receiving the control message may include operations, features, means, or instructions for receiving, from the network entity, the control message including the one or more timing parameters for the RRS configuration and one or more performance parameters.

In some examples of the method, apparatuses, and non-transitory computer-readable medium described herein, receiving the control message may include operations, features, means, or instructions for receiving, from the network entity, the control message including the one or more timing parameters for the RRS configuration, where the one or more timing parameters for the RRS configuration may be based on one or more performance parameters.

Some examples of the method, apparatuses, and non-transitory computer-readable medium described herein may further include operations, features, means, or instructions for transmitting, to the network entity, one or more performance parameters, where receiving the control message may be based on transmitting the one or more performance parameters.

In some examples of the method, apparatuses, and non-transitory computer-readable medium described herein, receiving the control message may include operations, features, means, or instructions for receiving, from the network entity, the control message including one or more rules for determining the one or more timing parameters for the RRS configuration.

In some examples of the method, apparatuses, and non-transitory computer-readable medium described herein, setting the timing pattern for the RRS may include operations, features, means, or instructions for configuring the timing pattern based on the one or more rules received from the network entity.

In some examples of the method, apparatuses, and non-transitory computer-readable medium described herein, a rule of the one or more rules may be based on a polynomial and one or more performance parameters may be inputs to the polynomial.

In some examples of the method, apparatuses, and non-transitory computer-readable medium described herein, a rule of the one or more rules includes a restriction on a value of the one or more timing parameters for the RRS configuration.

In some examples of the method, apparatuses, and non-transitory computer-readable medium described herein, a rule of the one or more rules specifies if CPs with different durations may be allowed within a slot.

In some examples of the method, apparatuses, and non-transitory computer-readable medium described herein, the wireless device may be a JCR associated with a UE.

In some examples of the method, apparatuses, and non-transitory computer-readable medium described herein, the network entity may be a network entity or a roadside unit (RSU).

A method for wireless communications at a network entity is described. The method may include establishing a connection with a wireless device and transmitting, to the wireless device, a control message for an RRS configuration associated with the wireless device based on establishing the connection with the wireless device.

An apparatus for wireless communications at a network entity is described. The apparatus may include a processor, memory coupled with the processor, and instructions stored in the memory. The instructions may be executable by the processor to cause the apparatus to establish a connection with a wireless device and transmit, to the wireless device, a control message for an RRS configuration associated with the wireless device based on establishing the connection with the wireless device.

Another apparatus for wireless communications at a network entity is described. The apparatus may include means for establishing a connection with a wireless device and means for transmitting, to the wireless device, a control message for an RRS configuration associated with the wireless device based on establishing the connection with the wireless device.

A non-transitory computer-readable medium storing code for wireless communications at a network entity is described. The code may include instructions executable by a processor to establish a connection with a wireless device and transmit, to the wireless device, a control message for an RRS configuration associated with the wireless device based on establishing the connection with the wireless device.

In some examples of the method, apparatuses, and non-transitory computer-readable medium described herein, transmitting the control message may include operations, features, means, or instructions for transmitting, to the wireless device, the control message including one or more timing parameters for the RRS configuration and one or more performance parameters.

In some examples of the method, apparatuses, and non-transitory computer-readable medium described herein, transmitting the control message may include operations, features, means, or instructions for transmitting, to the wireless device, the control message including one or more timing parameters for the RRS configuration, where the one or more timing parameters for the RRS configuration may be based on one or more performance parameters.

Some examples of the method, apparatuses, and non-transitory computer-readable medium described herein may further include operations, features, means, or instructions for receiving, from the wireless device, one or more performance parameters, where transmitting the control message may be based on receiving the one or more performance parameters.

In some examples of the method, apparatuses, and non-transitory computer-readable medium described herein, transmitting the control message may include operations, features, means, or instructions for transmitting, to the wireless device, the control message including one or more rules for determining one or more timing parameters for the RRS configuration.

In some examples of the method, apparatuses, and non-transitory computer-readable medium described herein, a rule of the one or more rules may be based on a polynomial and one or more performance parameters may be inputs to the polynomial.

In some examples of the method, apparatuses, and non-transitory computer-readable medium described herein, a rule of the one or more rules includes a restriction on a value of the one or more timing parameters for the RRS configuration.

In some examples of the method, apparatuses, and non-transitory computer-readable medium described herein, the one or more rules specifies if CPs with different durations may be allowed within a slot.

In some examples of the method, apparatuses, and non-transitory computer-readable medium described herein, the network entity may be a network entity or an RSU.

In some examples of the method, apparatuses, and non-transitory computer-readable medium described herein, the wireless device may be a JCR associated with a UE.

### BRIEF DESCRIPTION OF THE DRAWINGS

FIG. 1 illustrates an example of a wireless communications system that supports a radar reference signal (RRS) for joint communication radar (JCR) in accordance with aspects of the present disclosure.

FIG. 2 illustrates an example of a wireless communications system that supports an RRS for JCR in accordance with aspects of the present disclosure.

FIG. 3 illustrates an example of a resource configuration that supports an RRS for JCR in accordance with aspects of the present disclosure.

FIG. 4 illustrates an example of a resource configuration that supports an RRS for JCR in accordance with aspects of the present disclosure.

FIG. 5 illustrates an example of a process flow that supports an RRS for JCR in accordance with aspects of the present disclosure.

FIGS. 6 and 7 show block diagrams of devices that support an RRS for JCR in accordance with aspects of the present disclosure.

FIG. 8 shows a block diagram of a communications manager that supports an RRS for JCR in accordance with aspects of the present disclosure.

FIG. 9 shows a diagram of a system including a device that supports an RRS for JCR in accordance with aspects of the present disclosure.

FIGS. 10 and 11 show block diagrams of devices that support an RRS for JCR in accordance with aspects of the present disclosure.

FIG. 12 shows a block diagram of a communications manager that supports an RRS for JCR in accordance with aspects of the present disclosure.

FIG. 13 shows a diagram of a system including a device that supports an RRS for JCR in accordance with aspects of the present disclosure.

FIGS. 14 through 17 show flowcharts illustrating methods that support an RRS for JCR in accordance with aspects of the present disclosure.

### DETAILED DESCRIPTION

Some wireless communications systems may support radar signaling, which may be performed by traditional radars or by joint communication radars (JCRs). A JCR may be capable of communication-based signaling (e.g., data and control signaling) as well as radar signaling (e.g., for estimating properties associated with nearby objects). In some cases, a JCR may use communication-centric waveforms for both communications and radar signaling, which may present challenges associated with selecting signaling parameters (e.g., timing parameters) that achieve desirable performance for communications and radar signaling. For example, radar signaling may, in some cases, be associated with longer path lengths when compared to communication-based signaling. Specifically, some radar applications may utilize long-distance ranging methods. Additionally, radar signaling may be reflected in cases where an equivalent communication signal may follow a direct, unidirectional path.

In some cases, communication-based signals and radar signals may propagate over multiple paths. Accordingly, a JCR may receive multiple instances of a signal, which may be received at different times depending on a path length associated with each instance of the signal. A time interval between a first instance of a signal and a last instance of a signal may be referred to as delay spread. In some cases, delay spread may increase with path length. In some cases, a JCR may be unable to effectively decode a signal if a symbol duration (e.g., a cyclic prefix (CP) duration) is small when compared to a delay spread associated with the signal. Inter-symbol interference (ISI) and inter-carrier interference (ICI) may result if a CP is smaller than a delay spread (e.g., a sampling error may occur). However, increasing the duration of a CP or reducing sub-carrier spacing (SCS), which may indirectly increase the relative duration of a CP with respect to the sampling window, may result in a reduced data rate for communications, which may be undesirable.

In accordance with aspects of the present disclosure a JCR may configure a radar reference signal (RRS) according to a timing pattern (e.g., a resource configuration) based on a control message from a network entity. The RRS may enable the JCR to achieve desired performance outcomes for communications and radar signaling. For example, the timing pattern for the RRS may enable the JCR to reduce ISI and ICI, while maintaining a desired CP duration, which may effectively maintain a desired data rate for communications. The timing pattern for the RRS may include a quantity of repetitions of a CP as well as an RRS symbol (e.g., an “RRS Main”). The JCR may receive a plurality of reflected radar signals (e.g., a plurality of instances of a delay signal associated with a delay spread). The JCR may sample (e.g., using Fast Fourier Transforms (FFTs)) the received signals using a same quantity of sampling windows as the quantity of CP repetitions, which may enable the JCR to reduce or eliminate ISI and ICI. The JCR may receive an indication including one or more parameters (e.g., timing parameters, performance parameters) which specify the RRS timing pattern from a network entity. Additionally or alternatively, the wireless device may determine the RRS timing pattern based on one or more rules specified by the network entity.

Aspects of the disclosure are initially described in the context of wireless communications systems. Aspects of the disclosure are further illustrated by and described with reference to apparatus diagrams, system diagrams, wireless communications systems, resource configurations, and flowcharts that relate to an RRS for JCR.

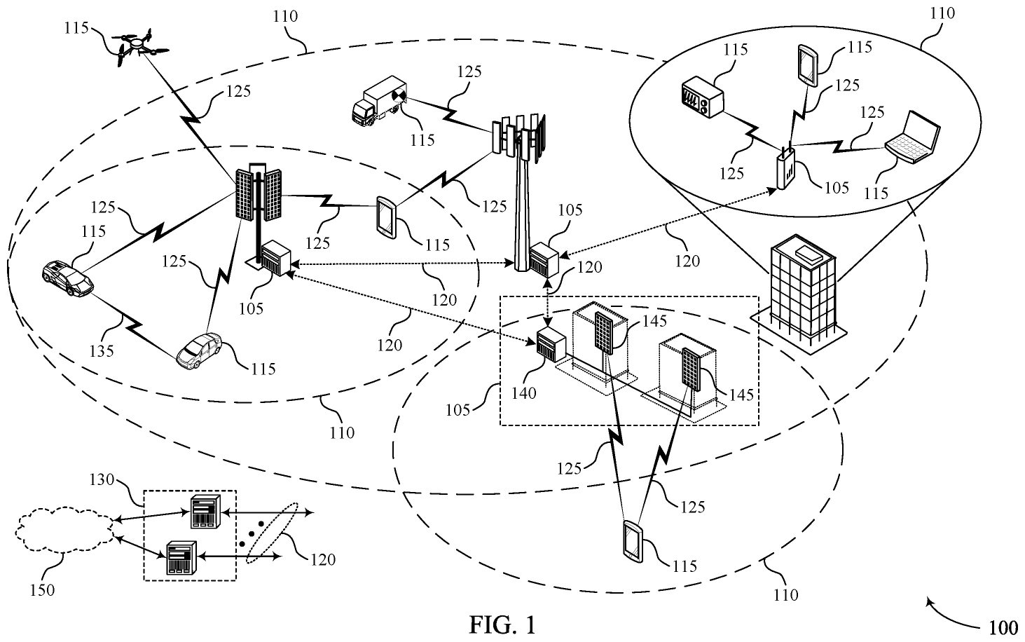

FIG. 1 illustrates an example of a wireless communications system 100 that supports an RRS for JCR in accordance with aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio network entity, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

In some examples, a network device 140 may be implemented in a disaggregated architecture (e.g., a disaggregated base station architecture, a disaggregated RAN architecture), which may be configured to utilize a protocol stack that is physically or logically distributed among two or more network devices 140, such as an IAB network, an open RAN (O-RAN) (e.g., a network configuration sponsored by the O-RAN Alliance), or a virtualized RAN (vRAN) (e.g., a cloud RAN (C-RAN)). For example, a network device 140 may include one or more of a central unit (CU), a distributed unit (DU), a radio unit (RU), a RAN Intelligent Controller (MC) (e.g., a Near-Real Time MC (Near-RT RIC), a Non-Real Time MC (Non-RT MC)), a Service Management and Orchestration (SMO) system, or any combination thereof. An RU may also be referred to as a radio head, a smart radio head, a remote radio head (RRH), a remote radio unit (RRU), or a transmission reception point (TRP). One or more components of the network devices 140 in a disaggregated RAN architecture may be co-located, or one or more components of the network devices 140 may be located in distributed locations (e.g., separate physical locations). In some examples, one or more network devices 140 of a disaggregated RAN architecture may be implemented as virtual units (e.g., a virtual CU (VCU), a virtual DU (VDU), a virtual RU (VRU)).

The split of functionality between a CU, a DU, and an RU is flexible and may support different functionalities depending upon which functions (e.g., network layer functions, protocol layer functions, baseband functions, RF functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some examples, the CU may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU. Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some cases, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU). A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some examples, a midhaul communication link or a fronthaul communication link may be implemented in accordance with an interface (e.g., a channel) between layers of a protocol stack supported by respective network devices 140 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network devices 140 (e.g., IAB nodes) may be partially controlled by each other. One or more IAB nodes may be referred to as a donor entity or an IAB donor. One or more DUs or one or more RUs may be partially controlled by one or more CUs associated with a donor network device 140 (e.g., a donor network entity 105). The one or more donor network devices 140 (e.g., IAB donors) may be in communication with one or more additional network devices 140 (e.g., IAB nodes) via supported access and backhaul links (e.g., backhaul communication links 120). IAB nodes may include an IAB mobile termination (IAB-MT) controlled (e.g., scheduled) by DUs of a coupled IAB donor. An IAB-MT may include an independent set of antennas for relay of communications with UEs 115, or may share the same antennas (e.g., of an RU) of an IAB node used for access via the DU of the IAB node (e.g., referred to as virtual IAB-MT (vIAB-MT)). In some examples, the IAB nodes may include DUs that support communication links with additional entities (e.g., IAB nodes, UEs 115) within the relay chain or configuration of the access network (e.g., downstream). In such cases, one or more components of the disaggregated RAN architecture (e.g., one or more IAB nodes or components of IAB nodes) may be configured to operate according to the techniques described herein.

For instance, an access network (AN) or RAN may include communications between access nodes (e.g., an IAB donor), IAB nodes, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU and at least one DU (e.g., and RU), in which case the CU may communicate with the core network 130 over an interface (e.g., a backhaul link). IAB donor and IAB nodes may communicate over an F1 interface according to a protocol that defines signaling messages (e.g., an F1 AP protocol). Additionally, or alternatively, the CU may communicate with the core network over an interface, which may be an example of a portion of backhaul link, and may communicate with other CUs (e.g., a CU associated with an alternative IAB donor) over an Xn-C interface, which may be an example of a portion of a backhaul link.

An IAB node may refer to a RAN node that provides IAB functionality (e.g., access for UEs 115, wireless self-backhauling capabilities). A DU may act as a distributed scheduling node towards child nodes associated with the IAB node, and the IAB-MT may act as a scheduled node towards parent nodes associated with the IAB node. That is, an IAB donor may be referred to as a parent node in communication with one or more child nodes (e.g., an IAB donor may relay transmissions for UEs through one or more other IAB nodes). Additionally, or alternatively, an IAB node may also be referred to as a parent node or a child node to other IAB nodes, depending on the relay chain or configuration of the AN. Therefore, the IAB-MT entity of IAB nodes may provide a Uu interface for a child IAB node to receive signaling from a parent IAB node, and the DU interface may provide a Uu interface for a parent IAB node to signal to a child IAB node or UE 115.

For example, IAB node may be referred to as a parent node that supports communications for a child IAB node, and referred to as a child IAB node associated with an IAB donor. The IAB donor may include a CU with a wired or wireless connection (e.g., a backhaul communication link 120) to the core network 130 and may act as parent node to IAB nodes. For example, the DU of IAB donor may relay transmissions to UEs 115 through IAB nodes, and may directly signal transmissions to a UE 115. The CU of IAB donor may signal communication link establishment via an F1 interface to IAB nodes, and the IAB nodes may schedule transmissions (e.g., transmissions to the UEs 115 relayed from the IAB donor) through the DUs. That is, data may be relayed to and from IAB nodes via signaling over an NR Uu interface to MT of the IAB node. Communications with IAB node may be scheduled by a DU of IAB donor and communications with IAB node may be scheduled by DU of IAB node.

In the case of the techniques described herein applied in the context of a disaggregated RAN architecture, one or more components of the disaggregated RAN architecture may be configured to support active interference cancellation for sidelink transmissions as described herein. For example, some operations described as being performed by a UE 115 or a network device 140 (e.g., a network entity 105) may additionally, or alternatively, be performed by one or more components of the disaggregated RAN architecture (e.g., IAB nodes, DUs, CUs, RUs, RIC, SMO).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N4 seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity, which may be an example of an access node controller (ANC). Each access network entity may communicate with the UEs 115 through one or more other access network transmission entities 145, which may be referred to as radio heads, smart radio heads, or transmission/reception points (TRPs). Each access network transmission entity may include one or more antenna panels. In some configurations, various functions of each access network entity or network entity 105 may be distributed across various network devices (e.g., radio heads and ANCs) or consolidated into a single network device (e.g., a network entity 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with aspects of the present disclosure, a UE 115, which may be described herein as a JCR or a wireless device, may transmit an RRS, which may include a slot structure that enables effective radar and communication-based signaling. For example, the RRS may enable the UE 115 to increase a range associated with radar signaling without decreasing a data rate or without introducing ICI or ISI. In some cases, the UE 115 may receive a control message from a network entity such as a network entity 105 and the UE 115 may configure the RRS based on the control message. The timing pattern for the RRS may include a quantity of repetitions of a CP as well as an RRS symbol (e.g., an “RRS Main”). The UE 115 may sample (e.g., using Fast Fourier Transforms (FFTs)) the received signals using a same quantity of sampling windows as the quantity of CP repetitions, which may enable the UE 115 to reduce or eliminate ISI and ICI. The UE 115 may receive an indication of parameters which specify the RRS timing pattern from the network entity 105. Alternatively, the UE 115 may determine the RRS timing pattern based on one or more rules specified by the network entity 105.

As described herein, a JCR may additionally or alternatively be referred to as a wireless device or a UE 115. In some cases, the term “JCR” may be used interchangeably with the term “wireless device” and the term “UE.” In some cases, it may be understood that a wireless device or a UE 115 is equipped with or otherwise associated with a JCR. For example, a wireless device may include software and hardware, which may enable the wireless device to perform both radar and communication-based signaling.

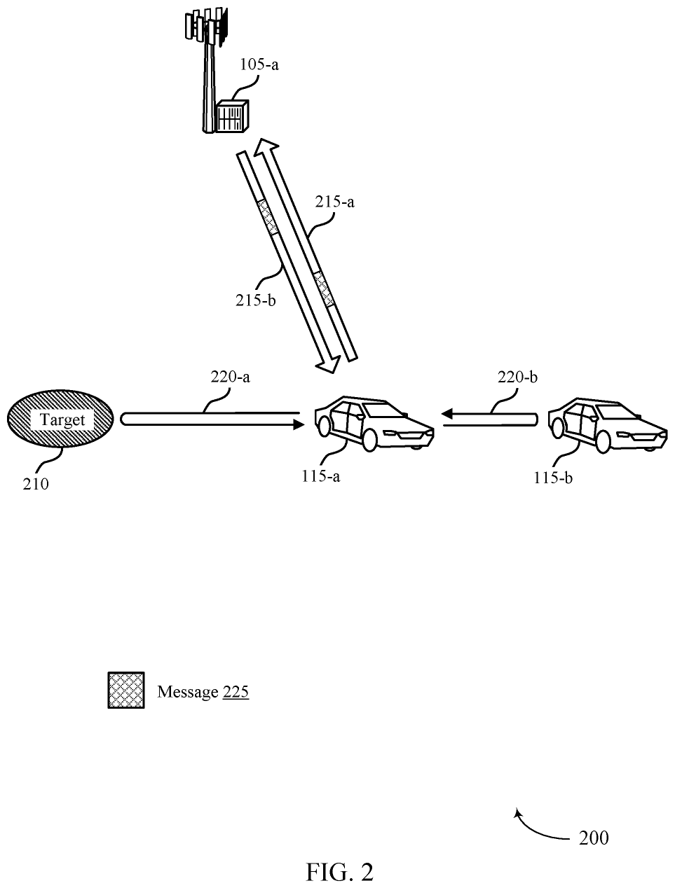

FIG. 2 illustrates an example of a wireless communications system 200 that supports an RRS for JCR in accordance with aspects of the present disclosure. The wireless communications system 200 may implement aspects of the wireless communications system 100. For example, the wireless communications system 200 may include a network entity 105-a, a wireless device 115-a, and a wireless device 115-b, which may be examples of a corresponding network entity 105 and corresponding UEs 115, respectively, as described with reference to FIG. 1. As described herein the term “wireless device 115” and “UE 115” may be used interchangeably. Additionally or alternatively, the network entity 105-a may include or may be referred to as a base station, a base transceiver station, a radio network entity, an access point, a radio transceiver, a NodeB, an eNB, a gNB, a Home NodeB, a Home eNodeB, or other suitable terminology. In some examples, network entity 105-a may include one or more components including a CU, DU, RU, or the like, which may be co-located, separate, or virtualized.

In some cases, the network entity 105-a and the wireless device 115-a may communicate over communication links 215, which may be examples of communication links 125 as described with reference to FIG. 1. As described herein, an uplink communication link 215-a and a downlink communication link 215-b may be examples of communication links 125. The wireless devices 115 may transmit communication-based signals and radar signals 220. For example, the wireless device 115-a may transmit one or more messages 225 via the uplink communications link 215-a and transmit radar signals 220. Radar signals 220 may be reflected off of one or more targets 210. In some other cases, a radar signal 220, such as radar signal 220-b, may be reflected off of one or more wireless devices 115-b.

In some cases, the wireless devices 115 may be examples of vehicles (e.g., vehicles in a vehicle-to-everything (V2X) network). As described herein, the wireless devices may be equipped with one or more JCRs, or equipment capable of transmitting and receiving both radar signaling 210 and communication-based signaling. In some cases, the term “JCR” may be used interchangeably with the term “wireless device” and the term “UE.” In some cases, it may be understood that a wireless device or a UE is equipped with or otherwise associated with a JCR.

The wireless communications system 200 may support a variety of types of radars, which may be used in automotive applications or other applications. For example, the wireless devices 115, may implement millimeter wave radars for applications associated with vehicular safety and traffic efficiency. A wireless device 115 (e.g., a radar or a wireless device equipped with a radar) may include a hardware module, which may support single-band operation. In some cases, wireless devices 115, which may operate in one or more automotive applications, may utilize a frequency band from 76 to 81 gigahertz (GHz).

In some cases, a wireless device 115-a may transmit a radar signal 220, which may be proprietary, to sense the environment. The radar signal 220 may be reflected by one or more surrounding objects, such as one or more targets 210 or a wireless device 115-b. The wireless device 115-a may be equipped with a radar receiver, which may receive the radar signal 220 using a full-duplex mode. The wireless device 115-a may process the radar signal 220 to estimate one or more of a range, a velocity, an angle, or any combination thereof associated with the target 210 or the wireless device 115-b.

The performance of a radar may be measured or evaluated based on one or more performance parameters. In some cases, one or more performance parameters may include key performance indicators (KPIs). For example, resolution, estimation accuracy, maximum and minimum range, maximum and minimum doppler shift, field of view (FoV), maximum quantity of targets detected, update rate, and update rate latency may be examples of KPIs. Additionally or alternatively, signal to interference and noise ratio (SINR) as well as other interference-based parameters may be examples of KPIs. In some cases, a radar may be evaluated using one or more KPIs based on an automotive application and environment.

A wireless device 115 may be capable of both communication-based signaling (e.g., data and control signaling) as well as radar signaling (e.g., for estimating properties associated with nearby objects). As described herein, a wireless device 115 capable of both communication-based and radar signaling may be referred to as a JCR. In some cases, a JCR (e.g., a wireless device 115) may be categorized as a cooperative JCR or a co-design JCR. A cooperative JCR, which may additionally or alternatively be referred to as a co-located and cooperative JCR, may be configured such that hardware for radar signaling and communication-based signaling is co-located on a singular wireless device 115. The cooperative JCR may be configured to share information and data between communication and radar systems, which may improve the performance of each system. In such cases, the core operation of the radar and communication systems may not be altered. For example, radar and communication systems may be synchronized, but may operate separately, using separate resources.

A co-design JCR may utilize a common transmitter and receiver for both radar signaling and communication-based signaling. In some cases, transmit waveforms, receiver processing configurations, or both may be modified for effective operation. A co-design JCR may utilize shared hardware and spectral resources for both radar and communications operations. In some cases, a co-design JCR may be further classified as a communication-centric JCR or a radar-centric JCR. A communication-centric JCR may utilize communication waveforms (e.g., OFDM or CDMA waveforms) for radar signaling. A radar-centric JCR may modulate communication messages on radar waveforms (e.g., phase-coded frequency modulated continuous wave (FMCW) waveforms).

A JCR may be configured to operate using a single frequency band or multiple frequency bands. For example, a single-band JCR may transmit communication and radar signaling using a 60 GHz band or a 140 GHz band. That is, a single-band JCR may select or may be configured to use a 60 GHz band for both radar and communication-based signaling. Additionally or alternatively, a single-band JCR may select or may be configured to use a 140 GHz band for both radar and communication-based signaling. A multi-band JCR may select or be configured to use both a 28 GHz band and a 60 GHz band. For example, a multi-band JCR may transmit communication-based signaling using a 60 GHz band and may transmit radar signaling using a 28 GHz band. Additionally or alternatively, the multi-band JCR may transmit communication-based signaling using the 28 GHz band and may transmit radar signaling using the 60 GHz band.

A JCR may be evaluated based on one or more radar KPIs and one or more communication KPIs. In some cases, the one or more radar KPIs may be associated with full-duplex radar signaling. In some cases, the one or more communication KPIs may be associated with half-duplex signaling. One or more radar KPIs may be associated with long range automotive radar (e.g., for adaptive cruise control). One or more communication KPIs may be associated with high data rate communication. In some cases, JCR KPIs may include link-level and system-level KPIs.

TABLE 1

| Parameter | Value (Example) |
|---|---|
| Range | 10-300 meters (m) |
| Azimuth (FoV) | ±15 degrees |
| Velocity | −75 to 60 meters/second (m/s) |
| Range Resolution | <0.1 m |
| Velocity Resolution | <0.6 m/s |
| Angular Resolution | 1-4 degrees |
| Maximum Quantity of Targets | 32 |
| Detected | |
| Data Rate | On the Order of Gigabits per |
| | second (Gbps) |
| Communication Latency | 100 milliseconds (ms) |

In some cases, as shown in Table 1, each KPI may be associated with a value (e.g., a threshold value, a specified minimum or maximum value, a range of values), which may be determined or defined based on one or more conditions.

As described herein, a communication-centric JCR may use communication-based waveforms (e.g., NR OFDM waveforms) for both communications and radar signaling. For example, the wireless device 115-a, which may be an example of a communication-centric JCR, or may be equipped with a communication-centric JCR may use communication-based waveforms to transmit communications to the network entity 105-a and to transmit radar signal 220-a, which may be reflected off of a target 210. However, a configuration of the communication-based waveform (e.g., a timing pattern) may not enable the wireless device 115-a to achieve sufficient performance when evaluated based on one or more KPIs. For example, the wireless device 115-a may be unable to effectively measure a pathlength between the wireless device 115-a and the target 210 because a delay spread associated with the pathlength may be large enough to produce ISI and ICI. To eliminate or reduce the effects of ISI and ICI, a duration of a CP may be increased, however, increasing the duration of the CP may reduce a data rate for communications.

A radar channel and delay profile may be estimated using a frequency domain estimation (FDE) method. As described herein, if a delay spread is larger than a CP length, previous symbol addition and current symbol loss may occur while processing received waveforms (e.g., for communication-based and radar signaling). In some cases, previous symbol addition and current symbol loss may result in correlated ISI and ICI noise and loss of radar target amplitude power, which may reduce a radar estimation and detection accuracy and coverage (e.g., maximum detectable radar target range. As shown below in Table 2, a maximum range of a radar signal 220 may increase with increasing CP length and decreasing SCS.

TABLE 2

| SCS | Normal CP | Maximum Range |
|---|---|---|
| 30 kilohertz (kHz) | 2.3 microseconds (μs) | 350 meters (m) |
| 120 kHz | 0.57 μs | 87.5 m |
| 480 kHz | 0.14 μs | 21.9 m |
| 960 kHz | 0.07 μs | 10.9 m |

In some cases, a wireless device 115, a network entity 105-a or both may decrease SCS to reduce or eliminate negative effects of large delay spread associated with a radar signal 220. However, decreasing SCS may increase signaling overhead (e.g., RRS overhead). In some cases, decreasing SCS may increase a symbol duration (e.g., symbol duration without a CP and CP duration). As a result, increased symbol duration may cause reduced communication efficiency. In some cases (e.g., at higher carrier frequencies), reducing SCS may be undesirable due to high phase noise. Additionally or alternatively, reducing SCS may pose challenges for achieving specified orthogonality in vehicle environments where doppler shift may be high. In some cases, other techniques for extending CP may result in an insufficient range for some radar applications. For example, an extended CP (ECP) for a 60 kHz SCS may be associated with 25% overhead. At higher carrier frequencies with high SCS (e.g., 960 kHz) a maximum range may be 39 m.

In some cases, a wireless device 115 may be unable to perform according to one or more performance parameters as a result of one or more limitations associated with CP quantity or CP duration, excessive delay spread, ICI, ISI, symbol loss, symbol addition, loss of signal power, or other factors. In some cases, a wireless device 115 may be unable to effectively decode a radar signal 220 if a CP is small when compared to a delay spread associated with the radar signal 220. Inter-symbol interference (ISI) and inter-carrier interference (ICI) may result if a CP is smaller than a delay spread (e.g., a sampling error may occur). However, increasing the duration of a CP or reducing sub-carrier spacing (SC S), which may indirectly increase the relative duration of a CP with respect to the sampling window, may result in a reduced data rate for communications, which may be undesirable.

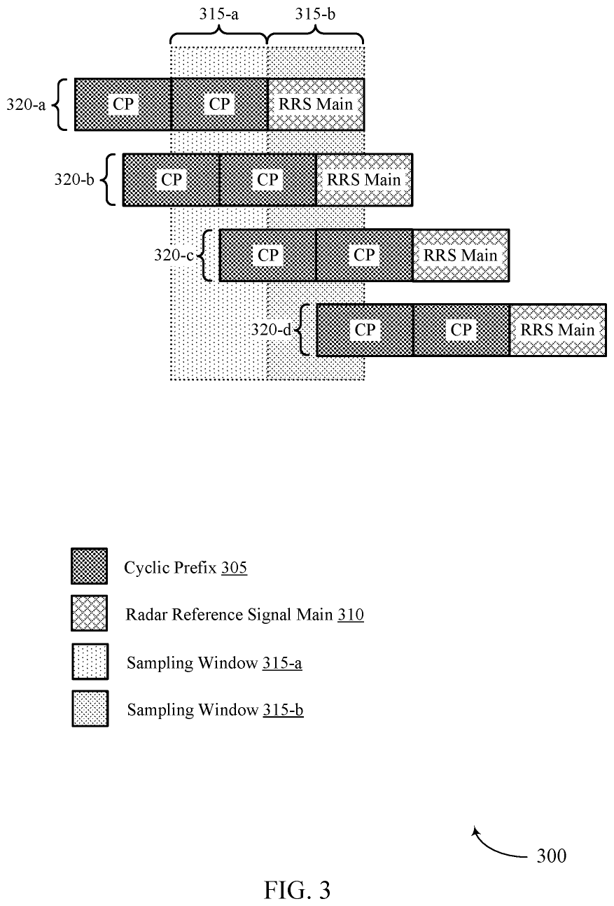

FIG. 3 illustrates an example of a resource configuration 300 that supports an RRS for JCR in accordance with aspects of the present disclosure. In some cases, the wireless communications system 100 or the wireless communications system 200 may implement aspects of the resource configuration 300. For example, a UE 115 or a wireless device 115 as described with reference to FIGS. 1 and 2, respectively, may implement aspects of the resource configuration 300. Additionally or alternatively, a network entity 105 as described with reference to FIGS. 1 and 2 may implement aspects of the resource configuration 300.

The resource configuration 300 may include one or more CPs 305 and one or more RRS mains 310, which may be transmitted by a wireless device 115 (e.g., a JCR). In some cases, a wireless device 115 may transmit signaling (e.g., radar signal 220 and communication-based signaling) along one or more paths 320. For example, a wireless device 115 may transmit a radar signal 220 in multiple directions, and each instance of the radar signal 220 may be associated with a path 320. In some cases, a wireless device 115 may receive each instance of the radar signal 220 (e.g., after the signal is reflected) at varying times due to a difference in a length of each path 320. In some cases, a radar signal 220 that travels along the second path 320-b may be a repetition of the radar signal 220 that travels along the first path 320-a. In some other cases the radar signal 220 that travels along the second path 320-b may be different from the radar signal 220 that travels along the first path 320-a (e.g., the second path 320-b may be associated with a different target 210). In some cases, the wireless device 115 may perform one or more processing operations on radar signal 220 based on one or more sampling windows 315.

In accordance with aspects of the present disclosure a wireless device 115 may transmit signaling (e.g., radar signal 220, communication-based signaling, or both) based on a timing pattern. The resource configuration 300 may illustrate an example of one such timing pattern. In some cases, an RRS symbol may include an RRS main 310 and a quantity of repetitions of CPs 305. The quantity of repetitions of CPs 305 may be represented by a variable, n. For example, a wireless device 115 may transmit a radar signal 220 along first path 320-a, which may include a symbol including two CPs 305 (n=2) and one RRS main 310. As illustrated with reference to the resource configuration 300, each path 320 may be shown to include one symbol. However, a path 320 may be associated with any quantity of symbols, which may not be shown in FIG. 3.

In some cases, a duration of an RRS main 310 may be 1/SCS. The RRS main 310 may include a training sequence associated with desirable correlation properties. Additionally or alternatively, the RRS main 310 may include communication transmit data known at a co-located radar receiver processing chain. A net duration of an RRS symbol may be (n+1)/SCS. For example, an RRS symbol may include two CPs 305, where n=2, and one RRS main 310. Accordingly, a net duration of the RRS symbol may be 3/SCS. A quantity of sampling windows 315 may be equal to a quantity of CPs 305 (e.g., n) within a symbol. For example, if the RRS symbol includes two CPs 305 and one RRS main 310, the quantity of sampling windows 315 may be two.

A wireless device 115 may receive one or more reflections of a radar signal 220. For example, the radar signal 220 may travel along one or more paths 320. The wireless device may perform one or more operations to process one or more reflections of the radar signal 220. For example, the wireless device may sample the radar signal 220 using one or more sampling windows 315, which may be associated with respective time intervals. In some cases, a sampling window 315 may be associated with performing an FFT. Additionally or alternatively, a sampling window 315 may be an example of an FFT window. In some cases, a wireless device 115 may perform one or more processing operations on a radar signal 220 using a quantity of sampling windows 315 equal to a quantity of CP 305 repetitions.

In some cases, sampling windows 315 may be aligned with sub-symbols of a first path 320-a. For example, a duration of a sampling window 315 may be identical to a duration of a sub-symbol. In some cases, a first sampling window 315-a may be aligned with a second CP 305 and a second sampling window 315-b may be aligned with an RRS main 310 (e.g., a first RRS main 310). In some cases, a first path 320-a and a second path 320-b may be offset by a delay spread. For example, a first CP 305 of the second path 320-b may begin during or span a portion of a first CP 305 of the first path 320-a. The delay spread may be smaller than a duration of a CP 305. As described herein, one or more sampling windows 315 may be identical in length to the duration of the CP 305. As a result, a delay profile observed using both sampling windows 315 may be a same delay profile.

The wireless device 115 may perform one or more processing operations (e.g., one or more FFTs) for each sampling window to determine one or more features associated with a radar signal 220 received along the first path 320-a and a radar signal 220 received along the second path 320-b. For example, the wireless device my perform an FFT for each sampling window 315 to determine a delay spread between two paths 320. The one or more processing operations may output similar or identical data for first sampling window 315-a and second sampling window 315-b, which may be used to determine a delay spread between the radar signal 220 received along the first path 320-a and the radar signal 220 received along the second path 320-b. In some cases, the one or more processing operations may output similar or identical data for first sampling window 315-a and second sampling window 315-b if each CP 305 and each sampling window 315 is larger than a delay spread between paths 320. In such cases, a wireless device 115 may determine or identify that a delay spread between a first path 320-a and a second path 320-b is smaller than a CP 305 duration based on determining that the first sampling window 315-a and the second sampling window 315-b yield a same delay profile.

In some other cases, a delay spread may be larger than a CP 305. For example, a delay spread between a first path 320-a and a third path 320-c may be larger than a CP 305. Accordingly, an FFT associated with the first sampling window 315-a may output a different delay profile than an FFT associated with the second sampling window 315-b. Specifically, an FFT associated with the first sampling window 315-a may output a delay profile including a relatively large amount of noise (e.g., ICI and ISI) when compared to a delay profile output by an FFT associated with the second sampling window 315-b. Accordingly, the wireless device 115 may determine or identify that a delay spread between the first path 320-a and the third path 320-c is larger than a CP 305. Additionally or alternatively, the wireless device 115 may distinguish the third path 320-c from the second path 320-b or fourth path 320-d based on the delay profiles corresponding to each respective FFT.

In some other cases, a delay spread may be larger than two CPs 305. For example, a delay spread between a first path 320-a and fourth path 320-d may be larger than two CPs 305. Accordingly an FFT associated with the first sampling window 315-a may output a different delay profile than an FFT associated with the second sampling window 315-b. Specifically, an FFT associated with the first sampling window 315-a may output a delay profile including a relatively small amount of noise (e.g., ICI and ISI) when compared to a delay profile output by an FFT associated with the second sampling window 315-b. Accordingly, the wireless device 115 may determine or identify that a delay spread between the first path 320-a and the fourth path 320-d is larger than two CPs 305. Additionally or alternatively, the wireless device 115 may distinguish the fourth path 320-d from the third path 320-c or the second path 320-b based on the delay profiles corresponding to each respective FFT.

As described herein, a wireless device 115 may implement a quantity of sampling windows 315 equal to a quantity of CP 305 repetitions. Accordingly, the wireless device may resolve a delay spread between paths 320 where the delay spread is larger than the CP 305 duration. Additionally or alternatively, by using multiple sampling windows 315, a wireless device may identify a path 320 based on one or more outputs of one or more processing operations associated with each sampling window 315. In some cases, a wireless device 115 implementing multiple sampling windows 315 may resolve delay spread ambiguity and increase a maximum range for radar signal 220.

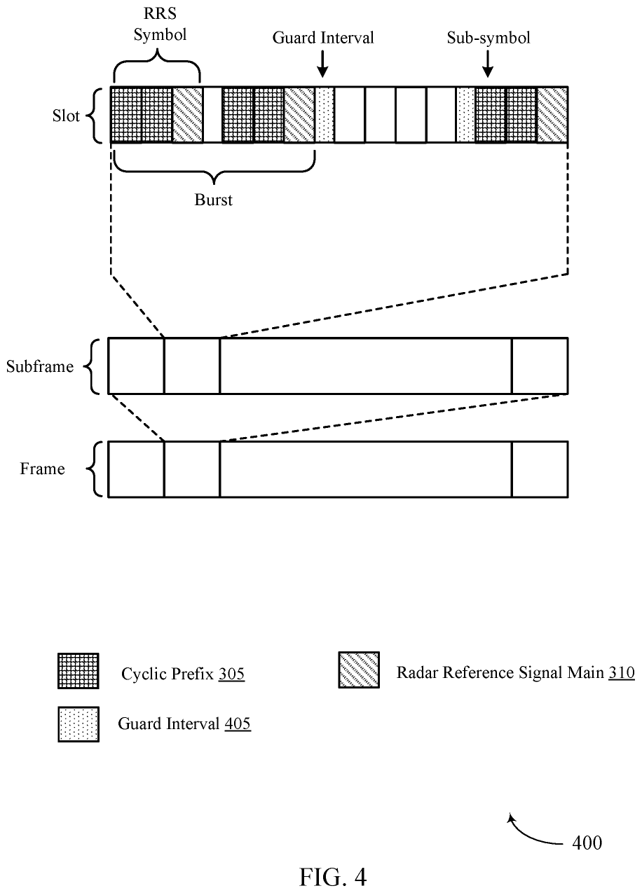

FIG. 4 illustrates an example of a resource configuration 400 that supports an RRS for JCR in accordance with aspects of the present disclosure. In some cases, the wireless communications system 100 or the wireless communications system 200 may implement aspects of the resource configuration 400. For example, a UE 115 or a wireless device 115 as described with reference to FIGS. 1 and 2, respectively, may implement aspects of the resource configuration 400. Additionally or alternatively, a network entity 105 as described with reference to FIGS. 1 and 2, may implement aspects of the resource configuration 400.

The resource configuration 400 may include one or more CPs 305 and one or more RRS mains 310, which may be transmitted by a wireless device 115 (e.g., a JCR). Additionally or alternatively, the resource configuration 400 may include one or more guard intervals (GIs) 405 and one or more data sub-symbols. The resource configuration 400 may illustrate time-frequency resources for communication-based signals and radar signals 220. For example, the resource configuration 400 may show the relative positioning (e.g., temporal positioning) of sub-symbols within a symbol, symbols within a slot, slots within a subframe, and subframes within a frame. In some cases, a burst may include multiple repetitions of an RRS symbol. Additionally or alternatively, a burst may include one or more data sub-symbols.

A quantity of repetitions of RRS symbols within a burst may be represented by a variable, m. For example, as shown in FIG. 4, a burst may include two RRS symbols, and m may be equal to 2. In some cases, a larger quantity of RRS symbols (e.g., higher m) may result in an improved signal-to-noise ratio (SNR). In some cases, a slot may include multiple bursts, which may be separated by a time gap. A time gap between bursts may include one or more GIs 405 and one or more data sub-symbols. A wireless device 115 may select a small time gap such that a target may be effectively tracked and a doppler shift may be effectively estimated. In some cases, a GI 405 may be included between bursts to reduce interference between an RRS symbol and data symbols.

A subframe may include multiple slots. In some cases, a subframe may have a duration of 1 ms. In some cases, if a subframe includes multiple slots, the RRS timing pattern may be repeated within the subframe. For example, the subframe may include multiple repetitions of a same burst, which may include multiple repetitions of a same RRS symbol. In some cases, a frame (e.g., an NR frame) may have a duration of 10 ms. As described herein, the RRS timing pattern may depend on one or more design parameters (e.g., timing parameters, performance parameters). For example, the RRS timing pattern may depend on radar KPIs, communication KPIs, a vehicular environment, a location of a device node, a location of a radar target, a velocity of a device node, and a velocity of a radar target.

A wireless device 115 or a network entity 105 may determine a timing pattern for an RRS based on one or more timing parameters. For example, the one or more timing parameters may include a quantity of CPs 305, n, a quantity of repetitions of RRS symbols, m, an indication of a gap between one or more RRS bursts, a GI 405 location, and a GI 405 duration. Accordingly, the wireless device 115 may transmit one or more RRSs based on the one or more timing parameters. For example, if n=2 and m=3, the wireless device 115 may transmit an RRS including three RRSs symbols, where each RRS symbol includes two CPs 305 and one RRS main 310. Additionally or alternatively, the wireless device 115 may determine whether to include a gap between RRS bursts, a location of a GI 405, and a GI 405 location.

One or more timing parameters may be based on one or more performance parameters (e.g., performance indicators, KPIs) as well as RF capabilities. For example, a quantity of repeated CPs 305, n, may be based on a maximum radar range, a radar target detection and estimation accuracy, a carrier frequency and SCS, or any combination thereof. In some cases, a high maximum radar range may correspond to a large n, a high radar target detection and estimation accuracy may correspond to a large n, and a high carrier frequency and SCS may correspond to a large n. Additionally or alternatively, a quantity of repeated RRS symbols, m, may be based on a maximum target range, a detection performance and estimation accuracy, and carrier frequency and SCS, or any combination thereof. For example, a high range may correspond to a large m, a high performance may correspond to a large m, and a high carrier frequency and SCS may correspond to a large m.

Additionally or alternatively, a gap between RRS bursts may be based on one or more performance parameters. For example, a gap between RRS bursts may be based on a maximum target doppler shift, a latency and update rate, or any combination thereof. In some cases, a high target doppler shift may correspond to a small or no gap between RRS bursts. Additionally or alternatively, a small latency rate and a high update rate may correspond to a small or no gap between RRS bursts. In some cases, a GI 405 location and duration may be based on one or more performance parameters, such as vehicular environment, location, mobility of device nodes, and mobility of radar targets. For example, a GI 405 may be large enough to reduce or eliminate interference between RRS sub-symbols and data sub-symbols.

In some cases, a wireless device 115 may receive a control message from a network entity 105, which may include one or more timing parameters. As described herein, the one or more timing parameters may include a quantity of CPs 305 (e.g., n), a quantity of repetitions of RRS symbols (e.g., m), an indication of a gap between one or more RRS bursts, a GI 405 location, and a GI 405 duration. The wireless device 115 may receive the control message and determine (e.g., calculate) a timing pattern for an RRS based on the one or more timing parameters included in the control message. In some cases, the control message may additionally include one or more performance parameters.

In some cases, a network entity 105 may transmit, to a wireless device 115, a control message including one or more rules for determining (e.g., calculating) one or more timing parameters for an RRS. Accordingly, the wireless device 115 may determine a timing pattern for the RRS based on one or more of the timing parameters and the one or more rules. The one or more rules may be based on a polynomial, where one or more performance parameters are inputs to the polynomial and one or more timing parameters are outputs of the polynomial. In some other cases, one or more rules may include a restriction on a value of one or more timing parameters. In some other cases, one or more rules may include an indication of whether CPs 305 with different durations are allowed within a slot.

A rule for determining an RRS timing pattern may be based on or may include a polynomial function. For example, the polynomial may output one or more timing parameters such as a quantity of repetitions of an RRS symbol, m. In some cases, the polynomial may include input variables R, a maximum radar range, C, a carrier frequency, A, a detection and estimation accuracy metric, T, a throughput, and L, a latency. In some cases, the function may be represented by the following expression: f(R, SCS, C, A, T, L)=m, where f, represents the polynomial function. The polynomial function, f, may be an example of a multi-variate polynomial function of a given degree. In some cases, a network entity 105 may transmit, to a wireless device 115, one or more coefficient parameters and a degree for the polynomial function.

A rule for determining an RRS timing pattern may be based on or may include one or more restrictions. For example, a rule may specify an allowed or restricted value of m for a given value of n. In some cases, the rule may specify the values of m and n for a common CP 305 design in a given slot. For example, a restriction on m may be determined based on an SCS and n. A restriction on m may be based on a slot boundary. For example, if an SCS is 960 kHz and n=2, m may be restricted to 0 or 5. Accordingly, an m of 0 or 5 may meet a slot boundary. In this case, another integer value of m would lead to a non-integer value of symbols with a normal CP 305 or an ECP of 25%. In some cases, a slot may support RRS symbol numerologies for its symbols or other CP/ECP for its symbols.

A rule for determining an RRS timing pattern may specific if mixed CP 305 design is allowed within a slot. That is, the rule may specify if CPs 305 with different durations are allowed within a slot. For example, if a SCS is 960 kHz and n=4, m may be a value between 0 and 3 if mixed CPs 305 within a slot is supported. In some case, if m=1, 8 ECP symbols or 4 ECP symbols may be allowed in a slot. However, if m=3, mixed CP 305 within a slot may not be allowed. In some cases, if a SCS is 960 kHz and n=2, m may be between 0 and 5 if mixed CPs 305 within a slot is supported. In such cases, a first portion of slots may include standard (e.g., 7%) CPs 305 and a second portion of slots may include ECPs (e.g., 25%). Additionally or alternatively, a portion of symbols (e.g., a first symbol after or before an RRS burst) may include a custom CP 305 to ensure that a slot duration is met. For example, if m=1, 11 symbols may have a standard CP 305 duration (7%) and one symbol may have a non-standard CP 305 duration (23%). In some cases, an extra CP length symbol may be used as a GI 405.

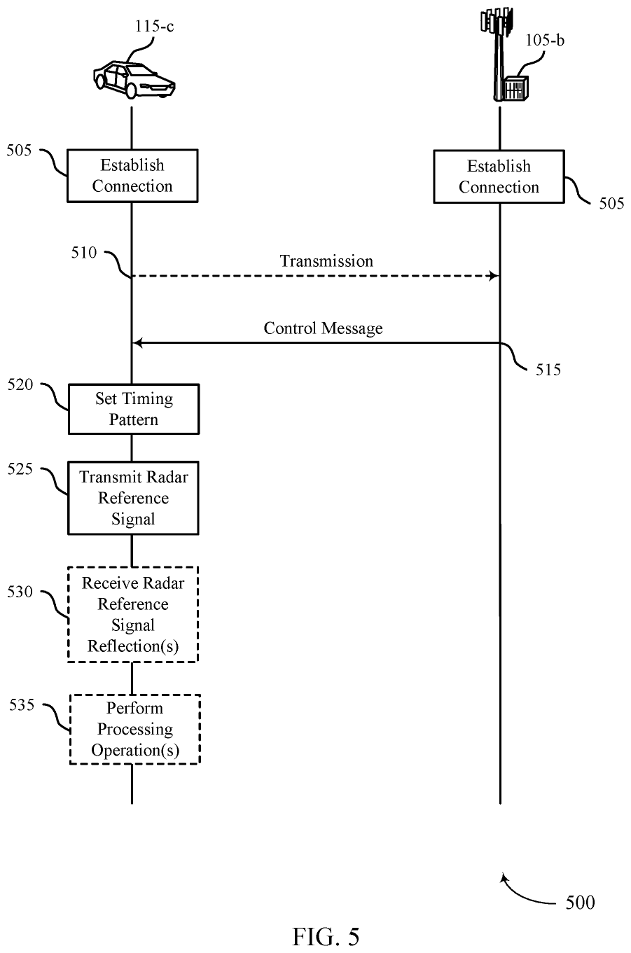

FIG. 5 illustrates an example of a process flow 500 that supports an RRS for JCR in accordance with aspects of the present disclosure. In some examples, process flow 500 may implement aspects of the wireless communications system 100 and 200. For example, process flow 500 may include wireless device 115-c, which may be an example of a corresponding UE 115 as described with reference to FIG. 1 or a corresponding wireless device 115 as described with reference to FIG. 2. Process flow 500 may also include network entity 105-b, which may be an example of a corresponding network entity 105 as described with reference to FIG. 1 or a corresponding network entity 105 as described with reference to FIG. 2. Additionally or alternatively, the network entity 105-b may include or may be referred to as a base station, a base transceiver station, a radio network entity, an access point, a radio transceiver, a NodeB, an eNB, a gNB, a Home NodeB, a Home eNodeB, or other suitable terminology. In some examples, network entity 105-b may include one or more components including a CU, DU, RU, or the like, which may be co-located, separate, or virtualized.

In the following description of process flow 500, the operations between the wireless device 115-c and the network entity 105-b may be transmitted in a different order than the order shown, or the operations may be performed at different times. Some operations may also be left out of process flow 500, or other operations may be added to process flow 500. While the wireless device 115-c is shown performing a number of the operations of process flow 500, any wireless device may perform the operations shown. For example, the network entity 105-b may perform the operations shown. In some cases, as described herein, the wireless device 115-c may be a JCR or may be equipped with a JCR. Additionally or alternatively, the network entity 105-b may be a roadside unit (RSU).

At 505, the network entity 105-b may establish a wireless connection with the wireless device 115-c. Additionally or alternatively, the wireless device 115-c may establish a wireless connection with the network entity 105-b. In some cases, establishing the wireless connection may include establishing one or more wireless communication links for transmitting and receiving information. For example, the network entity 105-b may establish a downlink communication link with the wireless device 115-c. Additionally or alternatively, the network entity 105-b may establish an uplink communication link with the wireless device 115-c. The network entity 105-b may transmit control signaling (e.g., a control message) to the wireless device 115-c via the downlink communication link. Additionally or alternatively, the wireless device 115-c may transmit information to the network entity 105-b via the uplink communication link.

At 510, the wireless device 115-c may transmit, to the network entity 105-b, one or more performance parameters. The one or more performance parameters may include one or more performance parameters associated with the wireless device 115-c. For example, the one or more performance parameters may include a resolution, an estimation accuracy, a maximum range, a minimum range, a doppler shift, a field of view, an update rate, an SINR, or other performance parameters. In some cases, one or more timing parameters for an RRS (e.g., an RRS timing pattern) may be based on the one or more performance parameters.

At 515, the wireless device 115-c may receive, from the network entity 105-b, a control message for an RRS configuration associated with the wireless device 115-c. In some cases, the control message may include the one or more timing parameters for the RRS configuration and one or more performance parameters. The control message may include the one or more timing parameters for the RRS configuration, where the one or more timing parameters for the RRS configuration are based on one or more performance parameters. The control message may include one or more rules for determining the one or more timing parameters for the RRS configuration where a rule of the one or more rules is based on a polynomial and one or more performance parameters are inputs to the polynomial. A rule of the one or more rules may include a restriction on a value of the one or more timing parameters for the RRS configuration. A rule of the one or more rules may specify if CPs 305 with different durations are allowed within a slot. In some cases, the wireless device 115-c receiving the control message is based on transmitting the one or more performance parameters.

At 520, the wireless device 115-c may set a timing pattern for the RRS based on the control message and the one or more timing parameters for the RRS configuration. For example, the timing pattern may specify a quantity of CPs 305 and RRS main 310 sub-symbols within an RRS symbol. In some cases, setting the timing pattern is based on the one or more rules received from the network entity 105-b. In some cases, the one or more rules may include a rule based on a polynomial and one or more performance parameters are inputs to the polynomial. In some cases, a rule may include a restriction on a value of the one or more timing parameters for the RRS configuration. In some other cases, a rule may specify if CPs 305 with different durations are allowed within a slot.

At 525, the wireless device 115-c may transmit the RRS according to the timing pattern. Transmitting the RRS may include transmitting one or more CP 305 sub-symbols and one or more RRS main 310 sub-symbols. In some cases, the wireless device 115-c may transmit a quantity of repetitions of the RRS. The wireless device 115-c may transmit a quantity of repetitions of the RRS based on the timing parameter of the one or more timing parameters. In some cases, repetitions of the RRS may be separated by one or more sub-symbols, one or more guard intervals, or a combination thereof. The wireless device 115-c may transmit the RRS in a direction of a target or another wireless device 115-c.

At 530, the wireless device 115-c may receive one or more reflections of the RRS based on transmitting the RRS. For example, the wireless device 115-c may transmit the RRS in the direction of a target. The RRS may be reflected by the target and the wireless device 115-c may receive the reflected RRS. In some cases, the target may be an example of a stationary object, a moving object, or a wireless device 115, which may be an example of a vehicle. The wireless device 115-c may receive the reflection using a receiving component, which may be configured to receive radar signaling and communications signaling.

At 535, the wireless device 115-c may perform one or more processing operations on the one or more reflections of the RRS using a plurality of sampling windows. In some cases, a quantity of sampling windows may be equal to a quantity of CP 305 sub-symbols. In some cases, performing one or more processing operations may include performing one or more FFTs on the one or more reflections of the RRS. The one or more processing operations may enable the wireless device 115-c to calculate or determine a range associated with a target. For example, the wireless device 115-c may determine a range of target such as another wireless device 115-c based on performing one or more processing operations on one or more RRSs reflected by the target.

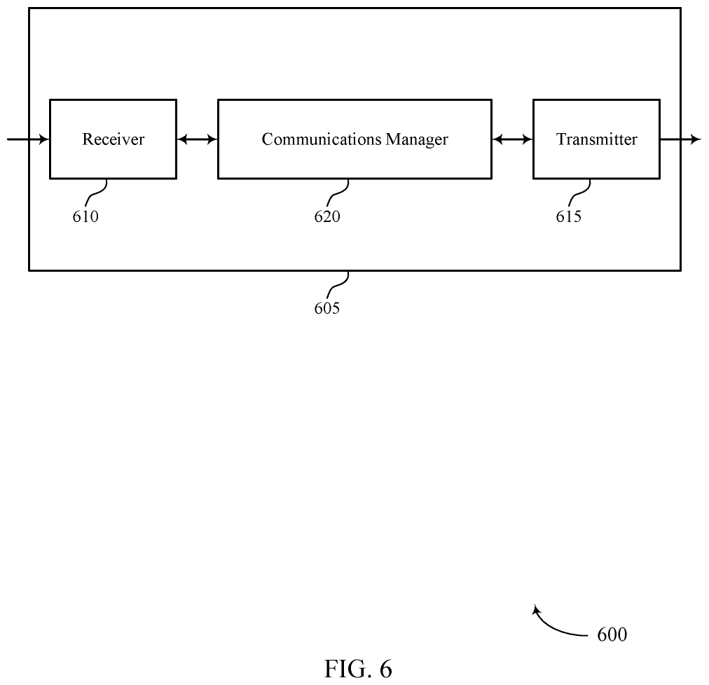

FIG. 6 shows a block diagram 600 of a device 605 that supports an RRS for JCR in accordance with aspects of the present disclosure. The device 605 may be an example of aspects of a UE 115 or a wireless device as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to radar reference signal for joint communication radar). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to radar reference signal for joint communication radar). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of radar reference signal for joint communication radar as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a wireless device in accordance with examples as disclosed herein. For example, the communications manager 620 may be configured as or otherwise support a means for receiving, from a network entity, a control message for a radar reference signal configuration associated with the wireless device. The communications manager 620 may be configured as or otherwise support a means for setting a timing pattern for the radar reference signal based on the control message and one or more timing parameters for the radar reference signal configuration. The communications manager 620 may be configured as or otherwise support a means for transmitting the radar reference signal according to the timing pattern.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for more efficient utilization of communication resources and improved coordination between devices. For example, the device 605 may support more efficient utilization of communication resources by transmitting one or more RRSs using a minimum quantity of time-frequency resources for effective signaling. Accordingly, the device 605 may reduce the processing overhead at the device 605. In some cases, transmitting one or more RRSs may improve communication throughput while reducing interference.

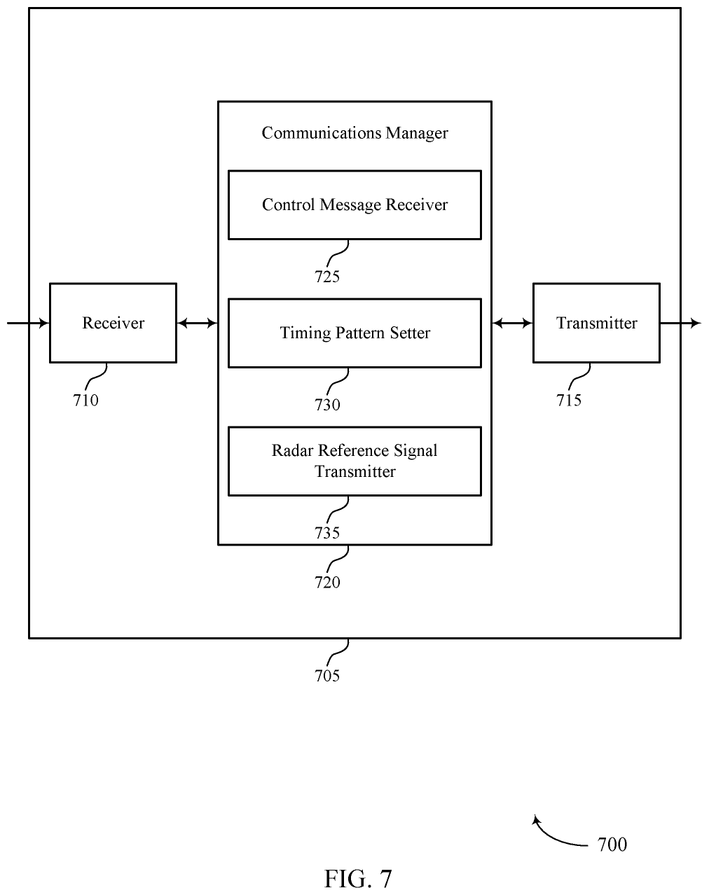

FIG. 7 shows a block diagram 700 of a device 705 that supports an RRS for JCR in accordance with aspects of the present disclosure. The device 705 may be an example of aspects of a device 605, a UE 115, or a wireless device as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to radar reference signal for joint communication radar). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to radar reference signal for joint communication radar). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of radar reference signal for joint communication radar as described herein. For example, the communications manager 720 may include a control message receiver 725, a timing pattern setter 730, a radar reference signal transmitter 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a wireless device in accordance with examples as disclosed herein. The control message receiver 725 may be configured as or otherwise support a means for receiving, from a network entity, a control message for a radar reference signal configuration associated with the wireless device. The timing pattern setter 730 may be configured as or otherwise support a means for setting a timing pattern for the radar reference signal based on the control message and one or more timing parameters for the radar reference signal configuration. The radar reference signal transmitter 735 may be configured as or otherwise support a means for transmitting the radar reference signal according to the timing pattern.

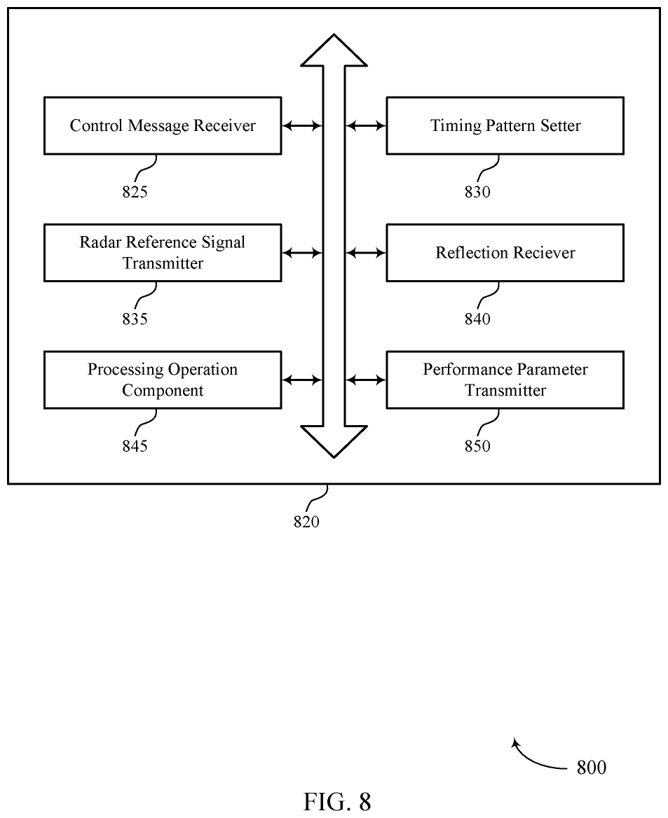

FIG. 8 shows a block diagram 800 of a communications manager 820 that supports an RRS for JCR in accordance with aspects of the present disclosure. The communications manager 820 may be an example of aspects of a communications manager 620, a communications manager 720, or both, as described herein. The communications manager 820, or various components thereof, may be an example of means for performing various aspects of radar reference signal for joint communication radar as described herein. For example, the communications manager 820 may include a control message receiver 825, a timing pattern setter 830, a radar reference signal transmitter 835, a reflection receiver 840, a processing operation component 845, a performance parameter transmitter 850, or any combination thereof. Each of these components may communicate, directly or indirectly, with one another (e.g., via one or more buses).

The communications manager 820 may support wireless communications at a wireless device in accordance with examples as disclosed herein. The control message receiver 825 may be configured as or otherwise support a means for receiving, from a network entity, a control message for a radar reference signal configuration associated with the wireless device. The timing pattern setter 830 may be configured as or otherwise support a means for setting a timing pattern for the radar reference signal based on the control message and one or more timing parameters for the radar reference signal configuration. The radar reference signal transmitter 835 may be configured as or otherwise support a means for transmitting the radar reference signal according to the timing pattern.

In some examples, to support transmitting the radar reference signal, the radar reference signal transmitter 835 may be configured as or otherwise support a means for transmitting the radar reference signal including one or more cyclic prefix (CP) sub-symbols and one or more radar reference signal sub-symbols.

In some examples, the reflection receiver 840 may be configured as or otherwise support a means for receiving one or more reflections of the radar reference signal based on transmitting the radar reference signal. In some examples, the processing operation component 845 may be configured as or otherwise support a means for performing one or more processing operations on the one or more reflections of the radar reference signal using a set of multiple sampling windows, where a quantity of sampling windows is equal to a quantity of cyclic prefix (CP) sub-symbols.

In some examples, to support transmitting the radar reference signal, the radar reference signal transmitter 835 may be configured as or otherwise support a means for transmitting a quantity of repetitions of the radar reference signal based on the timing parameter of the one or more timing parameters.

In some examples, to support transmitting the quantity of repetitions of the radar reference signal, the radar reference signal transmitter 835 may be configured as or otherwise support a means for transmitting the quantity of repetitions of the radar reference signal, where repetitions of the radar reference signal are separated by one or more sub-symbols, separated by one or more guard intervals, or a combination thereof.

In some examples, to support receiving the control message, the control message receiver 825 may be configured as or otherwise support a means for receiving, from the network entity, the control message including the one or more timing parameters for the radar reference signal configuration and one or more performance parameters.

In some examples, to support receiving the control message, the control message receiver 825 may be configured as or otherwise support a means for receiving, from the network entity, the control message including the one or more timing parameters for the radar reference signal configuration, where the one or more timing parameters for the radar reference signal configuration are based on one or more performance parameters.

In some examples, the performance parameter transmitter 850 may be configured as or otherwise support a means for transmitting, to the network entity, one or more performance parameters, where receiving the control message is based on transmitting the one or more performance parameters.

In some examples, to support receiving the control message, the control message receiver 825 may be configured as or otherwise support a means for receiving, from the network entity, the control message including one or more rules for determining the one or more timing parameters for the radar reference signal configuration.

In some examples, to support setting the timing pattern for the radar reference signal, the timing pattern setter 830 may be configured as or otherwise support a means for configuring the timing pattern based on the one or more rules received from the network entity.

In some examples, a rule of the one or more rules is based on a polynomial and one or more performance parameters are inputs to the polynomial.

In some examples, a rule of the one or more rules includes a restriction on a value of the one or more timing parameters for the radar reference signal configuration.

In some examples, a rule of the one or more rules specifies if cyclic prefixes (CPs) with different durations are allowed within a slot.

In some examples, the wireless device is a joint communication radar associated with a UE.

In some examples, the network entity may be a roadside unit.

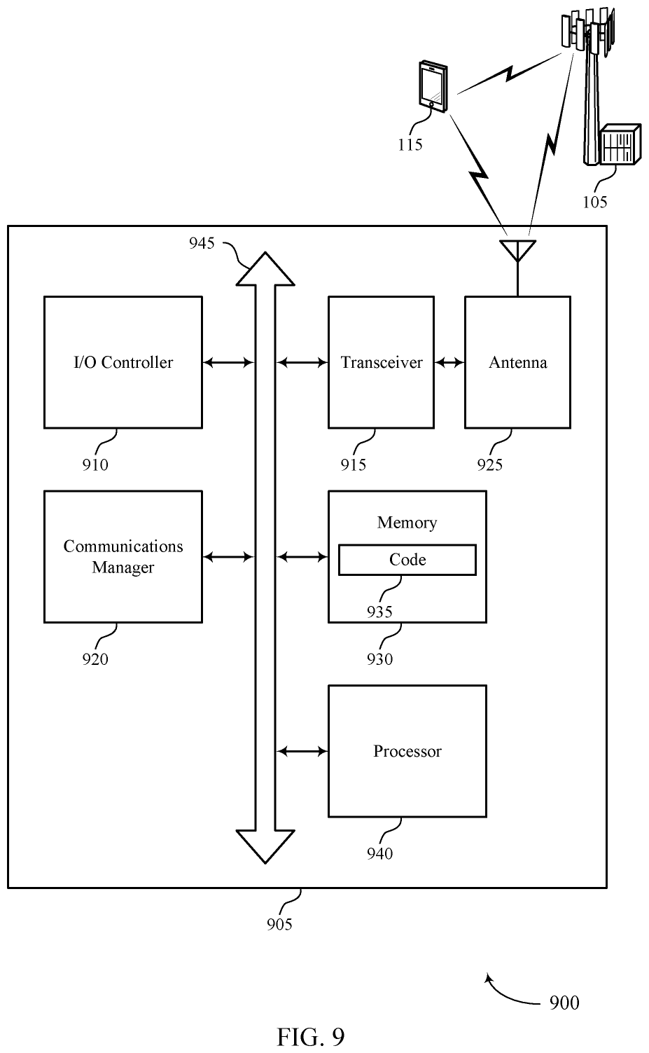

FIG. 9 shows a diagram of a system 900 including a device 905 that supports an RRS for JCR in accordance with aspects of the present disclosure. The device 905 may be an example of or include the components of a device 605, a device 705, a UE 115, or any other wireless device as described herein. The device 905 may communicate wirelessly with one or more network entities 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting radar reference signal for joint communication radar). For example, the device 905 or a component of the device 905 may include a processor 940 and memory 930 coupled with or to the processor 940, the processor 940 and memory 930 configured to perform various functions described herein.

The communications manager 920 may support wireless communications at a wireless device in accordance with examples as disclosed herein. For example, the communications manager 920 may be configured as or otherwise support a means for receiving, from a network entity, a control message for a radar reference signal configuration associated with the wireless device. The communications manager 920 may be configured as or otherwise support a means for setting a timing pattern for the radar reference signal based on the control message and one or more timing parameters for the radar reference signal configuration. The communications manager 920 may be configured as or otherwise support a means for transmitting the radar reference signal according to the timing pattern.

By including or configuring the communications manager 920 in accordance with examples as described herein, the device 905 may support techniques for reduced latency, more efficient utilization of time-frequency resources, and improved coordination between devices. For example, the device 905 may support reduced latency associated with reduced or optimized utilization of time-frequency resources for RRS signaling. In some cases, the device 905 may select a quantity of CPs and a CP duration, which may increase throughput and decrease latency associated with receiving and processing both radar signaling and communication-based signaling. In some cases, the device 905 may transmit one or more RRSs, which may reduce ISI and ICI, thereby improving coordination between devices. Additionally or alternatively, the device 905 may transmit one or more RRSs according to a timing pattern which may improve a signaling range of the device 905. Accordingly, the device 905 may implement one or more timing patterns for radar and communication signaling, which may increase user safety.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of radar reference signal for joint communication radar as described herein, or the processor 940 and the memory 930 may be otherwise configured to perform or support such operations.

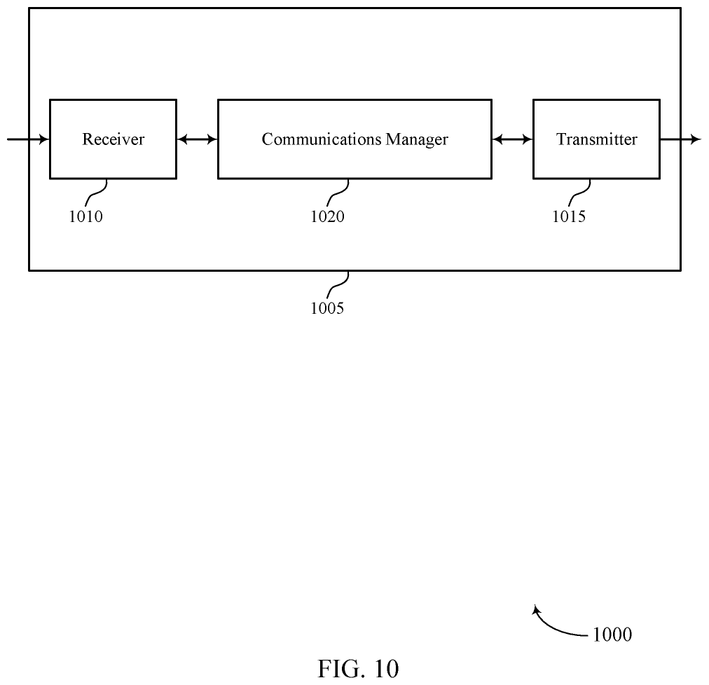

FIG. 10 shows a block diagram 1000 of a device 1005 that supports an RRS for JCR in accordance with aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses). Additionally or alternatively, the device 1005 may include or may be referred to as a base station, a base transceiver station, a radio network entity, an access point, a radio transceiver, a NodeB, an eNB, a gNB, a Home NodeB, a Home eNodeB, or other suitable terminology. In some examples, the device 1005 may include one or more components including a CU, DU, RU, or the like, which may be co-located, separate, or virtualized.

The receiver 1010 may provide a means for receiving information such as packets, user data, control information, or any combination thereof associated with various information channels (e.g., control channels, data channels, information channels related to radar reference signal for joint communication radar). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to radar reference signal for joint communication radar). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of radar reference signal for joint communication radar as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a network entity in accordance with examples as disclosed herein. For example, the communications manager 1020 may be configured as or otherwise support a means for establishing a connection with a wireless device. The communications manager 1020 may be configured as or otherwise support a means for transmitting, to the wireless device, a control message for a radar reference signal configuration associated with the wireless device based on establishing the connection with the wireless device.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for more efficient utilization of communication resources and improved coordination between devices. For example, the device 1005 may support more efficient utilization of communication resources by transmitting one or more RRSs using a minimum quantity of time-frequency resources for effective signaling. Accordingly, the device 1005 may reduce the processing overhead at the device 1005. In some cases, transmitting one or more RRSs may improve communication throughput while reducing interference.

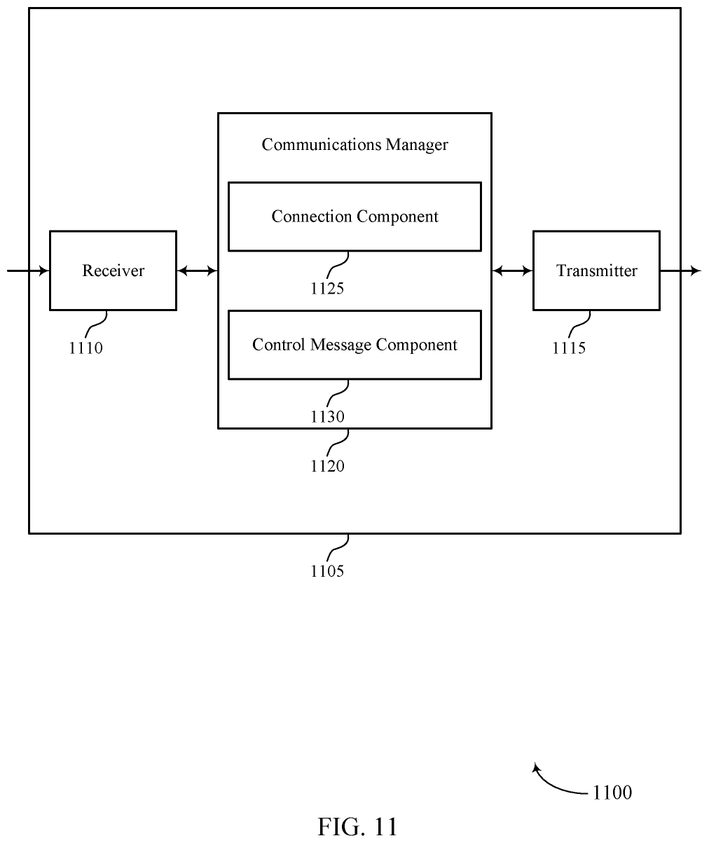

FIG. 11 shows a block diagram 1100 of a device 1105 that supports an RRS for JCR in accordance with aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to radar reference signal for joint communication radar). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to radar reference signal for joint communication radar). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of radar reference signal for joint communication radar as described herein. For example, the communications manager 1120 may include a connection component 1125 a control message component 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a network entity in accordance with examples as disclosed herein. The connection component 1125 may be configured as or otherwise support a means for establishing a connection with a wireless device. The control message component 1130 may be configured as or otherwise support a means for transmitting, to the wireless device, a control message for a radar reference signal configuration associated with the wireless device based on establishing the connection with the wireless device.

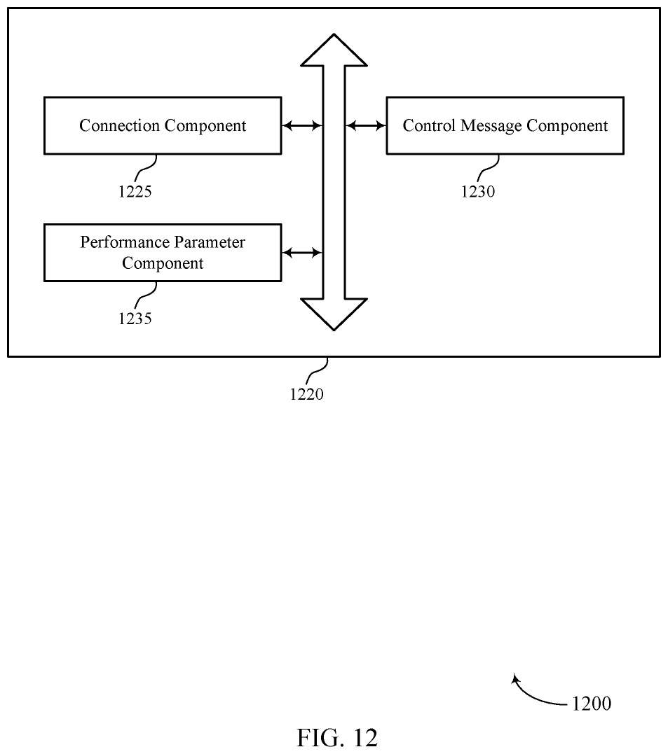

FIG. 12 shows a block diagram 1200 of a communications manager 1220 that supports an RRS for JCR in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of radar reference signal for joint communication radar as described herein. For example, the communications manager 1220 may include a connection component 1225, a control message component 1230, a performance parameter component 1235, or any combination thereof. Each of these components may communicate, directly or indirectly, with one another (e.g., via one or more buses).

The communications manager 1220 may support wireless communications at a network entity in accordance with examples as disclosed herein. The connection component 1225 may be configured as or otherwise support a means for establishing a connection with a wireless device. The control message component 1230 may be configured as or otherwise support a means for transmitting, to the wireless device, a control message for a radar reference signal configuration associated with the wireless device based on establishing the connection with the wireless device.

In some examples, to support transmitting the control message, the control message component 1230 may be configured as or otherwise support a means for transmitting, to the wireless device, the control message including one or more timing parameters for the radar reference signal configuration and one or more performance parameters.

In some examples, to support transmitting the control message, the control message component 1230 may be configured as or otherwise support a means for transmitting, to the wireless device, the control message including one or more timing parameters for the radar reference signal configuration, where the one or more timing parameters for the radar reference signal configuration are based on one or more performance parameters.

In some examples, the performance parameter component 1235 may be configured as or otherwise support a means for receiving, from the wireless device, one or more performance parameters, where transmitting the control message is based on receiving the one or more performance parameters.

In some examples, to support transmitting the control message, the control message component 1230 may be configured as or otherwise support a means for transmitting, to the wireless device, the control message including one or more rules for determining one or more timing parameters for the radar reference signal configuration.

In some examples, a rule of the one or more rules is based on a polynomial and one or more performance parameters are inputs to the polynomial.

In some examples, a rule of the one or more rules includes a restriction on a value of the one or more timing parameters for the radar reference signal configuration.

In some examples, the one or more rules specifies if cyclic prefixes (CPs) with different durations are allowed within a slot.

In some examples, the network entity may be a roadside unit.

In some examples, the wireless device is a joint communication radar associated with a UE.

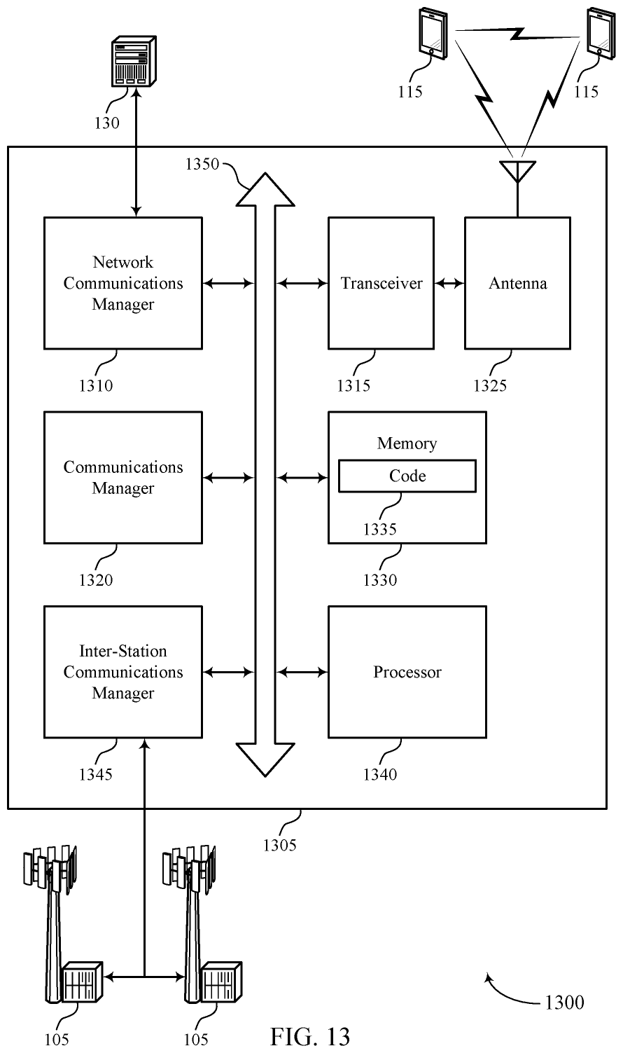

FIG. 13 shows a diagram of a system 1300 including a device 1305 that supports an RRS for JCR in accordance with aspects of the present disclosure. The device 1305 may be an example of or include the components of a device 1005, a device 1105, or a network entity 105 as described herein. The device 1305 may communicate wirelessly with one or more network entities 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting radar reference signal for joint communication radar). For example, the device 1305 or a component of the device 1305 may include a processor 1340 and memory 1330 coupled with or to the processor 1340, the processor 1340 and memory 1330 configured to perform various functions described herein.

The inter-station communications manager 1345 may manage communications with other network entities 105, and may include a controller or scheduler for controlling communications with UEs 115 in cooperation with other network entities 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for establishing a connection with a wireless device. The communications manager 1320 may be configured as or otherwise support a means for transmitting, to the wireless device, a control message for a radar reference signal configuration associated with the wireless device based on establishing the connection with the wireless device.

By including or configuring the communications manager 1320 in accordance with examples as described herein, the device 1305 may support techniques for reduced latency, more efficient utilization of time-frequency resources, and improved coordination between devices. For example, the device 1305 may support reduced latency associated with reduced or optimized utilization of time-frequency resources for RRS signaling. In some cases, the device 1305 may select a quantity of CPs and a CP duration, which may increase throughput and decrease latency associated with receiving and processing both radar signaling and communication-based signaling. In some cases, the device 1305 may transmit one or more RRSs, which may reduce ISI and ICI, thereby improving coordination between devices. Additionally or alternatively, the device 1305 may transmit one or more RRSs according to a timing pattern which may improve a signaling range of the device 1305. Accordingly, the device 1305 may implement one or more timing patterns for radar and communication signaling, which may increase user safety.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of radar reference signal for joint communication radar as described herein, or the processor 1340 and the memory 1330 may be otherwise configured to perform or support such operations.

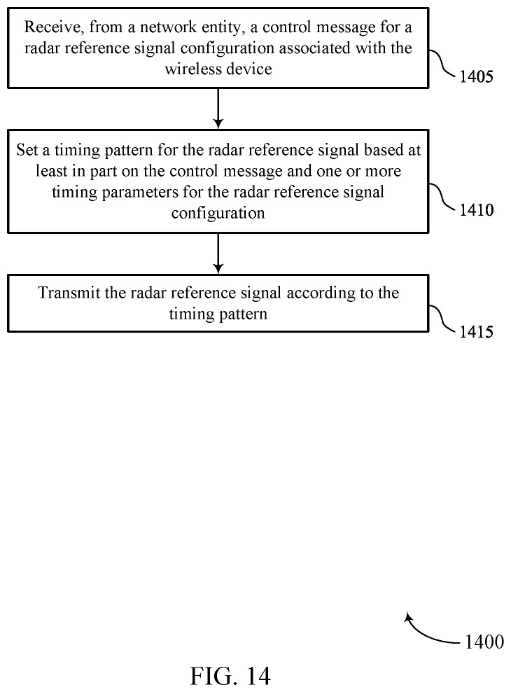

FIG. 14 shows a flowchart illustrating a method 1400 that supports an RRS for JCR in accordance with aspects of the present disclosure. The operations of the method 1400 may be implemented by a wireless device or its components as described herein. For example, the operations of the method 1400 may be performed by a UE 115 as described with reference to FIGS. 1 through 9. In some examples, a wireless device may execute a set of instructions to control the functional elements of the wireless device to perform the described functions. Additionally or alternatively, the wireless device may perform aspects of the described functions using special-purpose hardware.

At 1405, the method may include receiving, from a network entity, a control message for a radar reference signal configuration associated with the wireless device. The operations of 1405 may be performed in accordance with examples as disclosed herein. In some examples, aspects of the operations of 1405 may be performed by a control message receiver 825 as described with reference to FIG. 8.

At 1410, the method may include setting a timing pattern for the radar reference signal based on the control message and one or more timing parameters for the radar reference signal configuration. The operations of 1410 may be performed in accordance with examples as disclosed herein. In some examples, aspects of the operations of 1410 may be performed by a timing pattern setter 830 as described with reference to FIG. 8.

At 1415, the method may include transmitting the radar reference signal according to the timing pattern. The operations of 1415 may be performed in accordance with examples as disclosed herein. In some examples, aspects of the operations of 1415 may be performed by a radar reference signal transmitter 835 as described with reference to FIG. 8.

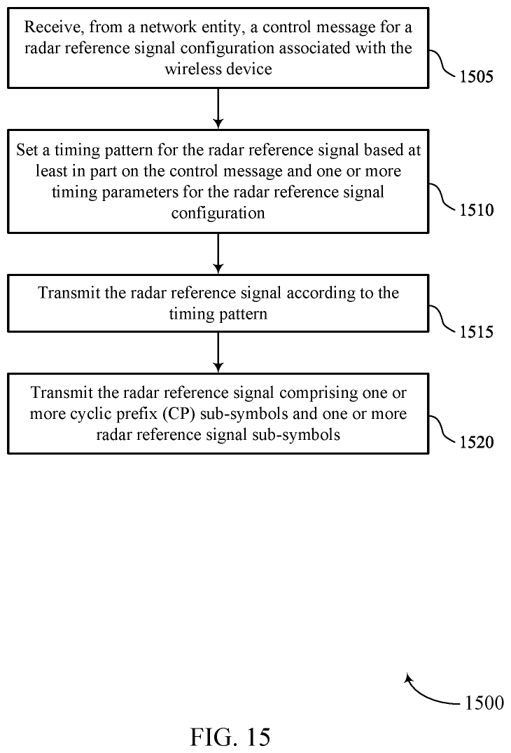

FIG. 15 shows a flowchart illustrating a method 1500 that supports an RRS for JCR in accordance with aspects of the present disclosure. The operations of the method 1500 may be implemented by a wireless device or its components as described herein. For example, the operations of the method 1500 may be performed by a UE 115 as described with reference to FIGS. 1 through 9. In some examples, a wireless device may execute a set of instructions to control the functional elements of the wireless device to perform the described functions. Additionally or alternatively, the wireless device may perform aspects of the described functions using special-purpose hardware.

At 1505, the method may include receiving, from a network entity, a control message for a radar reference signal configuration associated with the wireless device. The operations of 1505 may be performed in accordance with examples as disclosed herein. In some examples, aspects of the operations of 1505 may be performed by a control message receiver 825 as described with reference to FIG. 8.

At 1510, the method may include setting a timing pattern for the radar reference signal based on the control message and one or more timing parameters for the radar reference signal configuration. The operations of 1510 may be performed in accordance with examples as disclosed herein. In some examples, aspects of the operations of 1510 may be performed by a timing pattern setter 830 as described with reference to FIG. 8.

At 1515, the method may include transmitting the radar reference signal according to the timing pattern. The operations of 1515 may be performed in accordance with examples as disclosed herein. In some examples, aspects of the operations of 1515 may be performed by a radar reference signal transmitter 835 as described with reference to FIG. 8.

At 1520, the method may include transmitting the radar reference signal including one or more cyclic prefix (CP) sub-symbols and one or more radar reference signal sub-symbols. The operations of 1520 may be performed in accordance with examples as disclosed herein. In some examples, aspects of the operations of 1520 may be performed by a radar reference signal transmitter 835 as described with reference to FIG. 8.

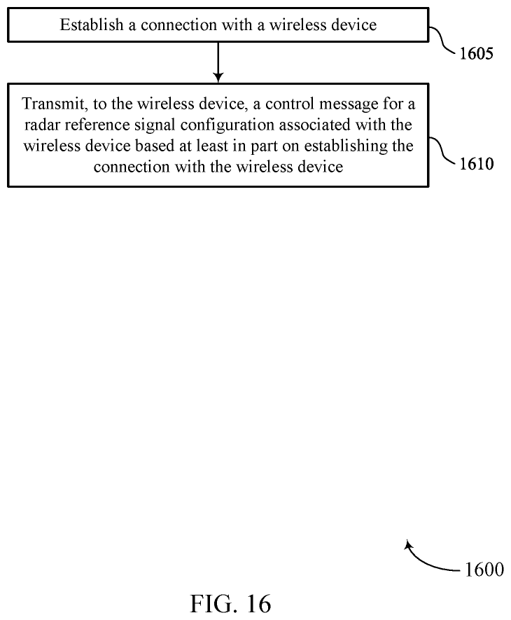

FIG. 16 shows a flowchart illustrating a method 1600 that supports an RRS for JCR in accordance with aspects of the present disclosure. The operations of the method 1600 may be implemented by a network entity or its components as described herein. For example, the operations of the method 1600 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1605, the method may include establishing a connection with a wireless device. The operations of 1605 may be performed in accordance with examples as disclosed herein. In some examples, aspects of the operations of 1605 may be performed by a connection component 1225 as described with reference to FIG. 12.

At 1610, the method may include transmitting, to the wireless device, a control message for a radar reference signal configuration associated with the wireless device based on establishing the connection with the wireless device. The operations of 1610 may be performed in accordance with examples as disclosed herein. In some examples, aspects of the operations of 1610 may be performed by a control message component 1230 as described with reference to FIG. 12.

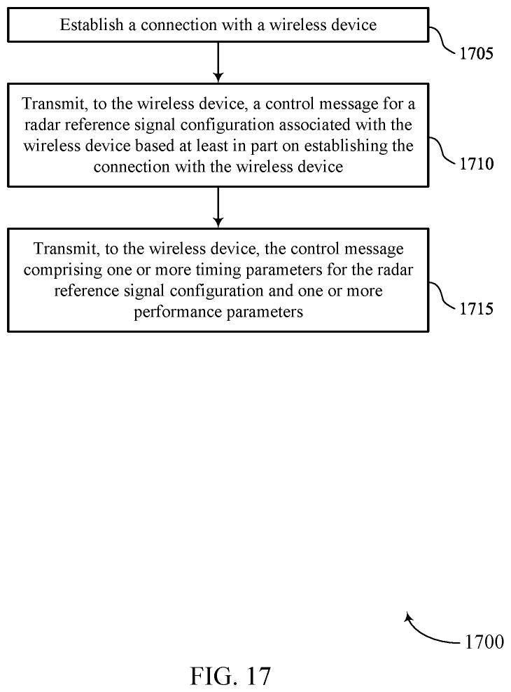

FIG. 17 shows a flowchart illustrating a method 1700 that supports an RRS for JCR in accordance with aspects of the present disclosure. The operations of the method 1700 may be implemented by a network entity or its components as described herein. For example, the operations of the method 1700 may be performed by a network entity 105 as described with reference to FIGS. 1 through 5 and 10 through 13. In some examples, a network entity may execute a set of instructions to control the functional elements of the network entity to perform the described functions. Additionally or alternatively, the network entity may perform aspects of the described functions using special-purpose hardware.

At 1705, the method may include establishing a connection with a wireless device. The operations of 1705 may be performed in accordance with examples as disclosed herein. In some examples, aspects of the operations of 1705 may be performed by a connection component 1225 as described with reference to FIG. 12.

At 1710, the method may include transmitting, to the wireless device, a control message for a radar reference signal configuration associated with the wireless device based on establishing the connection with the wireless device. The operations of 1710 may be performed in accordance with examples as disclosed herein. In some examples, aspects of the operations of 1710 may be performed by a control message component 1230 as described with reference to FIG. 12.

At 1715, the method may include transmitting, to the wireless device, the control message including one or more timing parameters for the radar reference signal configuration and one or more performance parameters. The operations of 1715 may be performed in accordance with examples as disclosed herein. In some examples, aspects of the operations of 1715 may be performed by a control message component 1230 as described with reference to FIG. 12.

The following provides an overview of aspects of the present disclosure:

Aspect 1: A method for wireless communications at a wireless device, comprising: receiving, from a network entity, a control message for a radar reference signal configuration associated with the wireless device; setting a timing pattern for the radar reference signal configuration based at least in part on the control message and one or more timing parameters for the radar reference signal configuration; and transmitting a radar reference signal according to the timing pattern.

Aspect 2: The method of aspect 1, wherein transmitting the radar reference signal comprises: transmitting the radar reference signal comprising one or more cyclic prefix (CP) sub-symbols and one or more radar reference signal sub-symbols.

Aspect 3: The method of any of aspects 1 through 2, further comprising: receiving one or more reflections of the radar reference signal based at least in part on transmitting the radar reference signal; and performing one or more processing operations on the one or more reflections of the radar reference signal using a plurality of sampling windows, wherein a quantity of sampling windows is equal to a quantity of cyclic prefix (CP) sub-symbols.

Aspect 4: The method of any of aspects 1 through 3, wherein transmitting the radar reference signal comprises: transmitting a quantity of repetitions of the radar reference signal based at least in part on a timing parameter of the one or more timing parameters.

Aspect 5: The method of aspect 4, wherein transmitting the quantity of repetitions of the radar reference signal comprises: transmitting the quantity of repetitions of the radar reference signal, wherein repetitions of the radar reference signal are separated by one or more sub-symbols, separated by one or more guard intervals, or a combination thereof.

Aspect 6: The method of any of aspects 1 through 5, wherein receiving the control message comprises: receiving, from the network entity, the control message comprising the one or more timing parameters for the radar reference signal configuration and one or more performance parameters.

Aspect 7: The method of any of aspects 1 through 5, wherein receiving the control message comprises: receiving, from the network entity, the control message comprising the one or more timing parameters for the radar reference signal configuration, wherein the one or more timing parameters for the radar reference signal configuration are based at least in part on one or more performance parameters.

Aspect 8: The method of any of aspects 1 through 5 and aspect 7, further comprising: transmitting, to the network entity, one or more performance parameters, wherein receiving the control message is based at least in part on transmitting the one or more performance parameters.

Aspect 9: The method of any of aspects 1 through 8, wherein receiving the control message comprises: receiving, from the network entity, the control message comprising one or more rules for determining the one or more timing parameters for the radar reference signal configuration.

Aspect 10: The method of aspect 9, wherein setting the timing pattern for the radar reference signal comprises: configuring the timing pattern based at least in part on the one or more rules received from the network entity.

Aspect 11: The method of any of aspects 9 through 10, wherein a rule of the one or more rules is based at least in part on a polynomial and one or more performance parameters are inputs to the polynomial.

Aspect 12: The method of any of aspects 9 through 11, wherein a rule of the one or more rules comprises a restriction on a value of the one or more timing parameters for the radar reference signal configuration.

Aspect 13: The method of any of aspects 9 through 12, wherein a rule of the one or more rules specifies if cyclic prefixes (CPs) with different durations are allowed within a slot.

Aspect 14: The method of any of aspects 1 through 13, wherein the wireless device is a joint communication radar associated with a UE.

Aspect 15: The method of any of aspects 1 through 14, wherein the network entity is a roadside unit.

Aspect 16: A method for wireless communications at a network entity, comprising: establishing a connection with a wireless device; and transmitting, to the wireless device, a control message for a radar reference signal configuration associated with the wireless device based at least in part on establishing the connection with the wireless device.

Aspect 17: The method of aspect 16, wherein transmitting the control message comprises: transmitting, to the wireless device, the control message comprising one or more timing parameters for the radar reference signal configuration and one or more performance parameters.

Aspect 18: The method of any of aspects 16 through 17, wherein transmitting the control message comprises: transmitting, to the wireless device, the control message comprising one or more timing parameters for the radar reference signal configuration, wherein the one or more timing parameters for the radar reference signal configuration are based at least in part on one or more performance parameters.

Aspect 19: The method of any of aspects 16 through 18, further comprising: receiving, from the wireless device, one or more performance parameters, wherein transmitting the control message is based at least in part on receiving the one or more performance parameters.

Aspect 20: The method of any of aspects 16 through 19, wherein transmitting the control message comprises: transmitting, to the wireless device, the control message comprising one or more rules for determining one or more timing parameters for the radar reference signal configuration.

Aspect 21: The method of aspect 20, wherein a rule of the one or more rules is based at least in part on a polynomial and one or more performance parameters are inputs to the polynomial.

Aspect 22: The method of any of aspects 20 through 21, wherein a rule of the one or more rules comprises a restriction on a value of the one or more timing parameters for the radar reference signal configuration.

Aspect 23: The method of any of aspects 20 through 22, wherein the one or more rules specifies if cyclic prefixes (CPs) with different durations are allowed within a slot.

Aspect 24: The method of any of aspects 16 through 23, wherein the network entity is a roadside unit.

Aspect 25: The method of any of aspects 16 through 24, wherein the wireless device is a joint communication radar associated with a UE.

Aspect 26: An apparatus for wireless communications at a wireless device, comprising a processor; memory coupled with the processor; and instructions stored in the memory and executable by the processor to cause the apparatus to perform a method of any of aspects 1 through 15.

Aspect 27: An apparatus for wireless communications at a wireless device, comprising at least one means for performing a method of any of aspects 1 through 15.

Aspect 28: A non-transitory computer-readable medium storing code for wireless communications at a wireless device, the code comprising instructions executable by a processor to perform a method of any of aspects 1 through 15.

Aspect 29: An apparatus for wireless communications at a network entity, comprising a processor; memory coupled with the processor; and instructions stored in the memory and executable by the processor to cause the apparatus to perform a method of any of aspects 16 through 25.

Aspect 30: An apparatus for wireless communications at a network entity, comprising at least one means for performing a method of any of aspects 16 through 25.

Aspect 31: A non-transitory computer-readable medium storing code for wireless communications at a network entity, the code comprising instructions executable by a processor to perform a method of any of aspects 16 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a wireless device, comprising:
receiving, from a network entity, a control message for a radar reference signal configuration associated with the wireless device;
setting a timing pattern for the radar reference signal configuration based at least in part on the control message and one or more timing parameters for the radar reference signal configuration; and
transmitting a radar reference signal according to the timing pattern.

2. The method of claim 1, wherein transmitting the radar reference signal comprises:
transmitting the radar reference signal comprising one or more cyclic prefix (CP) sub-symbols and one or more radar reference signal sub-symbols.

3. The method of claim 1, further comprising:
receiving one or more reflections of the radar reference signal based at least in part on transmitting the radar reference signal; and
performing one or more processing operations on the one or more reflections of the radar reference signal using a plurality of sampling windows, wherein a quantity of sampling windows is equal to a quantity of cyclic prefix (CP) sub-symbols.

4. The method of claim 1, wherein transmitting the radar reference signal comprises:
transmitting a quantity of repetitions of the radar reference signal based at least in part on a timing parameter of the one or more timing parameters.

5. The method of claim 4, wherein transmitting the quantity of repetitions of the radar reference signal comprises:
transmitting the quantity of repetitions of the radar reference signal, wherein repetitions of the radar reference signal are separated by one or more sub-symbols, separated by one or more guard intervals, or a combination thereof.

6. The method of claim 1, wherein receiving the control message comprises:
receiving, from the network entity, the control message comprising the one or more timing parameters for the radar reference signal configuration and one or more performance parameters.

7. The method of claim 1, wherein receiving the control message comprises:
receiving, from the network entity, the control message comprising the one or more timing parameters for the radar reference signal configuration, wherein the one or more timing parameters for the radar reference signal configuration are based at least in part on one or more performance parameters.

8. The method of claim 1, further comprising:
transmitting, to the network entity, one or more performance parameters, wherein receiving the control message is based at least in part on transmitting the one or more performance parameters.

9. The method of claim 1, wherein receiving the control message comprises:
receiving, from the network entity, the control message comprising one or more rules for determining the one or more timing parameters for the radar reference signal configuration.

10. The method of claim 9, wherein setting the timing pattern for the radar reference signal comprises:
configuring the timing pattern based at least in part on the one or more rules received from the network entity.

11. The method of claim 9, wherein a rule of the one or more rules is based at least in part on a polynomial and one or more performance parameters are inputs to the polynomial.

12. The method of claim 9, wherein a rule of the one or more rules comprises a restriction on a value of the one or more timing parameters for the radar reference signal configuration.

13. The method of claim 9, wherein a rule of the one or more rules specifies if cyclic prefixes (CPs) with different durations are allowed within a slot.

14. The method of claim 1, wherein the wireless device is a joint communication radar associated with a user equipment (UE).

15. The method of claim 1, wherein the network entity is a roadside unit.

16. A method for wireless communications at a network entity, comprising:
establishing a connection with a wireless device; and
transmitting, to the wireless device, a control message for a radar reference signal configuration associated with the wireless device based at least in part on establishing the connection with the wireless device.

17. The method of claim 16, wherein transmitting the control message comprises:
transmitting, to the wireless device, the control message comprising one or more timing parameters for the radar reference signal configuration and one or more performance parameters.

18. The method of claim 16, wherein transmitting the control message comprises:
transmitting, to the wireless device, the control message comprising one or more timing parameters for the radar reference signal configuration, wherein the one or more timing parameters for the radar reference signal configuration are based at least in part on one or more performance parameters.

19. The method of claim 16, further comprising:
receiving, from the wireless device, one or more performance parameters, wherein transmitting the control message is based at least in part on receiving the one or more performance parameters.

20. The method of claim 16, wherein transmitting the control message comprises:
transmitting, to the wireless device, the control message comprising one or more rules for determining one or more timing parameters for the radar reference signal configuration.

21. The method of claim 20, wherein a rule of the one or more rules is based at least in part on a polynomial and one or more performance parameters are inputs to the polynomial.

22. The method of claim 20, wherein a rule of the one or more rules comprises a restriction on a value of the one or more timing parameters for the radar reference signal configuration.

23. The method of claim 20, wherein the one or more rules specifies if cyclic prefixes (CPs) with different durations are allowed within a slot.

24. The method of claim 16, wherein the network entity is a roadside unit.

25. The method of claim 16, wherein the wireless device is a joint communication radar associated with a user equipment (UE).

26. An apparatus for wireless communications at a wireless device, comprising:
a processor;
memory coupled with the processor; and
instructions stored in the memory and executable by the processor to cause the apparatus to:
receive, from a network entity, a control message for a radar reference signal configuration associated with the wireless device;
setting a timing pattern for the radar reference signal configuration based at least in part on the control message and one or more timing parameters for the radar reference signal configuration; and
transmit a radar reference signal according to the timing pattern.

27. The apparatus of claim 26, wherein the instructions to transmit the radar reference signal are further executable by the processor to cause the apparatus to:
transmit the radar reference signal comprising one or more cyclic prefix (CP) sub-symbols and one or more radar reference signal sub-symbols.

28. The apparatus of claim 26, wherein the instructions are further executable by the processor to cause the apparatus to:
receive one or more reflections of the radar reference signal based at least in part on transmitting the radar reference signal; and
perform one or more processing operations on the one or more reflections of the radar reference signal using a plurality of sampling windows, wherein a quantity of sampling windows is equal to a quantity of cyclic prefix (CP) sub-symbols.

29. The apparatus of claim 26, wherein the instructions to transmit the radar reference signal are further executable by the processor to cause the apparatus to:
transmit a quantity of repetitions of the radar reference signal based at least in part on a timing parameter of the one or more timing parameters.

30. An apparatus for wireless communications at a network entity, comprising:
a processor;
memory coupled with the processor; and
instructions stored in the memory and executable by the processor to cause the apparatus to:
establish a connection with a wireless device; and
transmit, to the wireless device, a control message for a radar reference signal configuration associated with the wireless device based at least in part on establishing the connection with the wireless device.
